(19) United States
(12) Patent Application Publication
(10) Pub. No.: US 2008/0065514 A1
(43) Pub. Date: Mar. 13, 2008

(54) Personal inventory management and item exchange network

(75) Inventor: Brook L. Eaton, Los Altos Hills, CA (US)

Correspondence Address: KOKKA & BACKUS, PC, 200 PAGE MILL ROAD, SUITE 103, PALO ALTO, CA, 94306, US

(73) Assignee: Snitsig, Inc., Mountain View, CA (US)

(21) Appl. No.: 11/899,770

(22) Filed: Sep. 7, 2007

Related U.S. Application Data
(60) Provisional application No. 60/843,008, filed on Sep. 8, 2006.

(51) Int. Cl. G06Q 30/00; G06F 17/30; G06F 17/40

(52) U.S. Cl. 705/27

(57) ABSTRACT

Techniques for personal inventory management and item exchange network are described, including generating an interface using data associated with a personal inventory comprising an item listing, the interface being used to manage the personal inventory, the interface being generated by a system configured to provide one or more options to manage the personal inventory and to prevent access to the personal inventory, presenting the item listing in the interface, the interface being accessible by one or more endpoints and including a marketplace configured to perform an activity associated with the item listing, the data being used to present the item listing on a network, the item listing describing an item, and receiving an input associated with the item listing, the input indicating initiation of an activity associated with an item described by the item listing.

### CROSS REFERENCE TO RELATED APPLICATIONS

This application claims the benefit of U.S. Provisional Patent Application No. 60/843,008 filed Sep. 8, 2006 and entitled “System for exchanging, loaning, borrowing, and tracking personal belongings, inventorying personal belongings, and searching or browsing other people's inventories for the purpose of exchange, temporary loaning/borrowing or social networking,” which is herein incorporated by reference for all purposes.

1.10

### FIELD OF THE INVENTION

The present invention relates generally to computer programs, software applications, and electronic commerce and social networking. More specifically, techniques for a personal inventory management and item exchange network are described.

### BACKGROUND OF THE INVENTION

Personal items (“items”) such as clothing, music, money, furniture, compact discs (“CDs”), automobiles, bicycles, books, or any other type of personal belonging are often sold, bought, traded, exchanged, or donated using various problematic conventional techniques. Some conventional techniques can be used to provide a listing associated with an item in an aggregated set of listings, such as classifieds listings in a newspaper, an online marketplace, or an auction website. However, distribution of the classifieds listings is limited to the circulation among the print subscribers or readers, who are typically unknown to each other and have no relationship unless they engage in a transaction regarding a given item. Other conventional techniques such as specialized advertising publications, auction houses, or brokered transactions allow users to engage in interactions involving items. While targeted, these listings are often very limited since they are served only if a particular online viewer fits a certain profile or meets a set of specific parameters.

Other problematic conventional techniques limit interaction between users, preventing communication that could result in a beneficial transaction or the development of a mutually beneficial relationship. For example, classified listings may allow a user to post information regarding an item and contact information. However, classified listings do not allow users to engage in social networking activities or communicate within classifieds forum in a manner that may be contextually relevant to the items being listed. Other limitations of conventional techniques restrict viewing of item listings to an isolated group of users, such as confining users to viewing listings that are created and posted on a specific website, online auction, classifieds listings, or marketplace. Some conventional techniques restrict viewing item listings unless a user is logged in or registered on a given site. For example, only authorized or registered users of a conventional auction website or marketplace website are allowed to engage in transactions involving an item.

Conventional techniques do not allow for users to view items listed across a variety of domains, websites, or forum. While items may be tracked physically by a user, conventional techniques facilitate transactions and provide no additional information after a transaction has been concluded. Tracking items that are lent, borrowed, or otherwise exchanged is difficult because items are often loaned to friends, family members, or others and owners often forget or lose track of the status of an item. Difficulty may also occur because items are often lost or forgotten after being loaned to friends, family members, or others. If items are loaned to borrowers who are geographically remote from the item owner's locale, additional difficulty results when trying to retrieve or track the borrowed item. Further, some items are valuable or desirable to lend to others since services or other items can be bartered in exchange. However, conventional techniques do not allow users to track items in a personal inventory that are loaned or borrowed and are typically self-contained, standalone applications. Further, conventional techniques for inventory management do not allow for any type of social interaction (i.e., networking), or tracking (i.e., inventory management).

Thus, a solution for managing personal items and belongings without the limitations of conventional techniques is needed.

### BRIEF DESCRIPTION OF THE DRAWINGS

Various examples are disclosed in the following detailed description and the accompanying drawings:

FIG. 1 illustrates an exemplary system for personal inventory management and item exchange;

FIG. 2 illustrates an exemplary application for personal inventory management and item exchange;

FIG. 3 illustrates exemplary categories of activities enabled by personal inventory management and item exchange;

FIG. 4A illustrates an exemplary user interface for personal inventory management and item exchange;

FIG. 4B illustrates another exemplary user interface for personal inventory management and item exchange;

FIG. 4C illustrates yet another exemplary user interface for personal inventory management and item exchange;

FIG. 4D illustrates an alternative exemplary user interface for personal inventory management and item exchange;

FIG. 4E illustrates still another exemplary user interface for personal inventory management and item exchange;

FIG. 4F illustrates a further exemplary user interface for personal inventory management and item exchange;

FIG. 4G illustrates an additional exemplary user interface for personal inventory management and item exchange;

FIG. 4H illustrates another additional exemplary user interface for personal inventory management and item exchange;

FIG. 4I illustrates a further additional exemplary user interface for personal inventory management and item exchange;

FIG. 4J illustrates an exemplary status user interface;

FIG. 4K illustrates another exemplary status user interface;

FIG. 5A illustrates an alternative exemplary user interface for personal inventory management and item exchange;

FIG. 5B illustrates another alternative exemplary user interface for personal inventory management and item exchange;

FIG. 5C illustrates yet another alternative exemplary user interface for personal inventory management and item exchange;

FIG. 5D illustrates still another alternative exemplary user interface for personal inventory management and item exchange;

FIG. 6A illustrates an exemplary process for personal inventory management and item exchange;

FIG. 6B illustrates an exemplary sub-process for personal inventory management and item exchange;

FIG. 6C illustrates another exemplary sub-process for personal inventory management and item exchange;

FIG. 6D illustrates yet another exemplary sub-process for personal inventory management and item exchange;

FIG. 6E illustrates a further exemplary process for personal inventory management and item exchange;

FIG. 7 illustrates an alternative exemplary process for personal inventory management and item exchange; and

FIG. 8 illustrates an exemplary computer system suitable for personal inventory management and item exchange.

### DETAILED DESCRIPTION

Various embodiments or examples may be implemented in numerous ways, including as a system, a process, an apparatus, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided as examples and the described techniques may be practiced according to the claims without some or all of the accompanying details. For clarity, technical material that is known in the technical fields related to the embodiments has not been described in detail to avoid unnecessarily obscuring the description.

In some examples, the described techniques may be implemented as a computer program or application (“application”) or as a module or sub-component of another application. The described techniques may be implemented as software, hardware, firmware, circuitry, or a combination thereof. If implemented as software, the described techniques may be implemented using various types of programming, development, scripting, or formatting languages, frameworks, syntax, applications, protocols, objects, or techniques, including C, Objective C, C++, C#, Flex™, Java™, Javascript™, Ajax, COBOL, Fortran, ADA, XML, HTML, DHTML, XHTML, HTTP, XSL, XSLT, XMPP, WSDL, and others. Design, publishing, visual effects, and other types of applications such as Dreamweaver®, Shockwave®, Flash®, Fireworks®, and others may also be used to implement the described techniques. The described techniques may be varied and are not limited to the examples or descriptions provided.

Techniques for a personal inventory management and item exchange network are described, including providing data communication networking techniques to allow item owners to engage in transactions such as lending, borrowing, purchasing, selling, tracking social networking, and personal inventory management. In some examples, personal inventories may be privately managed (i.e., not publicly accessible for viewing or other activities by users other than the account owner associated with a given personal inventory) and items within the personal inventory may be selected for placement on one or more publicly accessible marketplaces. As an example, an Internet or web-based interface may be generated, rendered, and presented (i.e., displayed) on a display screen associated with a computing device at one or more endpoints (i.e., clients, peers, servers, end terminals, wireless, wired, mobile, cellular, and other types of devices), allowing users to manage items in their personal inventory (i.e., a collection of items (e.g., any type of object, physical, virtual, or otherwise that may be discretely identified and sold, purchased, exchanged, traded, borrowed, or loaned) owned, controlled, or otherwise managed by a user (i.e., person)), contact other owners and develop relationships, groups, communities, and other social networking relationships, and engage in transactions such as those described above. The described techniques may be used to implement private personal inventory management on publicly-accessible websites. If lending, borrowing, or exchanging items, users may also, in some examples, track the location or status (e.g., number of days an item has been lent or borrowed, purchase price of an item, item condition, and the like) of an item. In other examples, items may be listed using the techniques described herein, including posting an item listing on a remote website or location and receiving requests for the item, which may be presented in an organized manner on a single website or interface using the techniques described herein. By enabling wider dissemination (i.e., enabling the ability of item listings, descriptions, images, and the like to be published to web pages (“pages”) that are associated with the same or different domains) of information and data associated with items in a personal inventory, improved transactions may be achieved. In other words, items may be posted at various locations to a larger audience of potential borrowers, lenders, purchasers, sellers, and other types of users. Inquiries or requests regarding the item from any domain may be retrieved, presented, organized, and managed on an interface provided by systems, such as those described below. Further, items, users, transactions, and other aspects of the described techniques may be implemented using a point value, point rating, credit rating, or other rating/scoring system or algorithm. By rating, ranking, or otherwise assigning value to items, transactions, and relationships between users, efficiency and effectiveness of personal inventory management is improved. When implemented with social networking and transaction or commerce capabilities such as those described below, further improvement may be achieved.

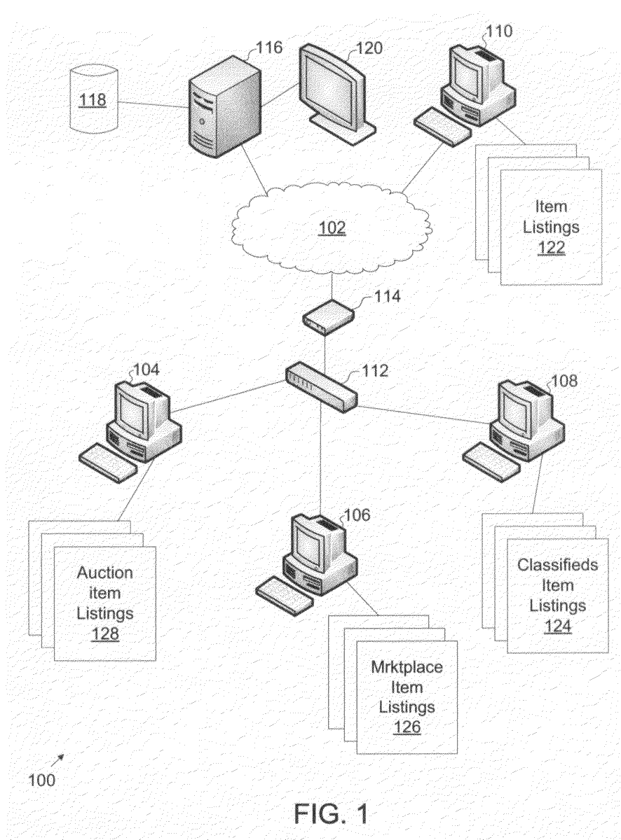

FIG. 1 illustrates an exemplary system for personal inventory management and item exchange. Here, system 100 includes network 102, endpoints 104-110, router 112, modem 114, server 116, database 118, display 120, and item listings 122-128. In some examples, system 100 and the above-described elements may be varied in number, configuration, implementation, and type without limitation to the examples provided. For example, one or more networks may also be coupled together in data communication to create an expansive data network that allows item postings at various endpoints. As another example, items may be listed by posting item listings or descriptions at a client (e.g., clients 104-110), which may be coupled to network using, for example, router 112 and modem 114. In other examples, clients 104-110 may be coupled to network 102 using different types of networking equipment apart from those shown and described. Networking equipment (e.g., router 112, modem 114) may be varied and are not limited to the configurations shown and described. For example, clients may be coupled directly (e.g., client 110) to network 102 using, for example, an internal network interface card.

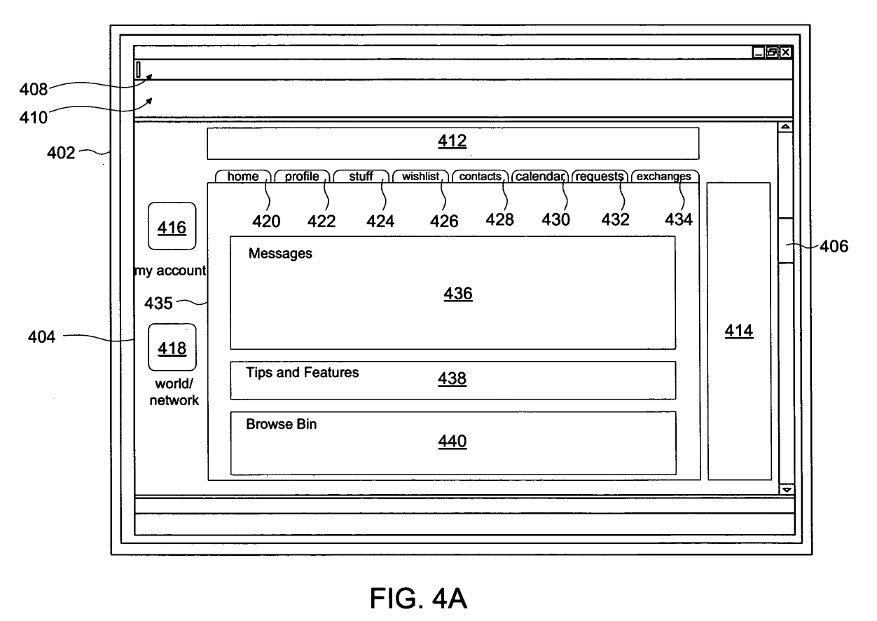

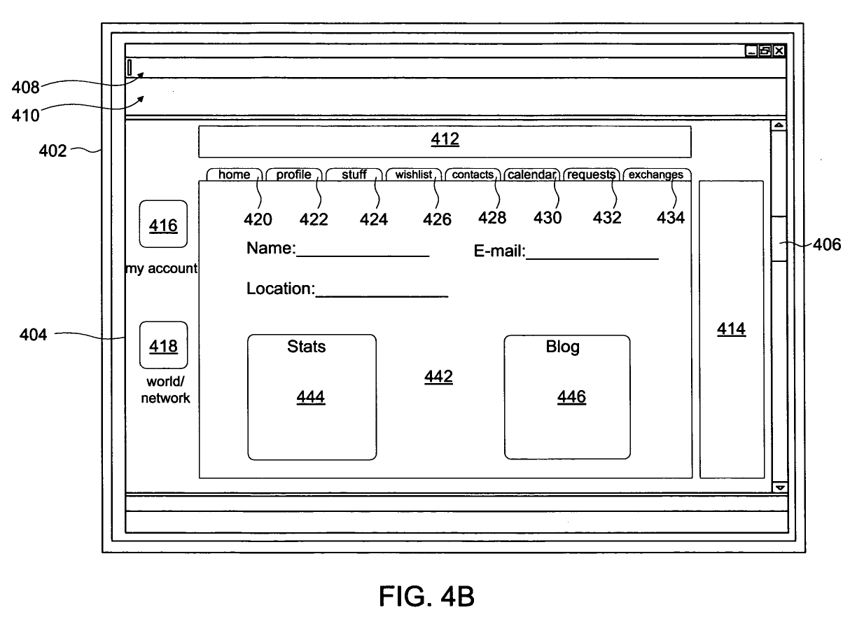

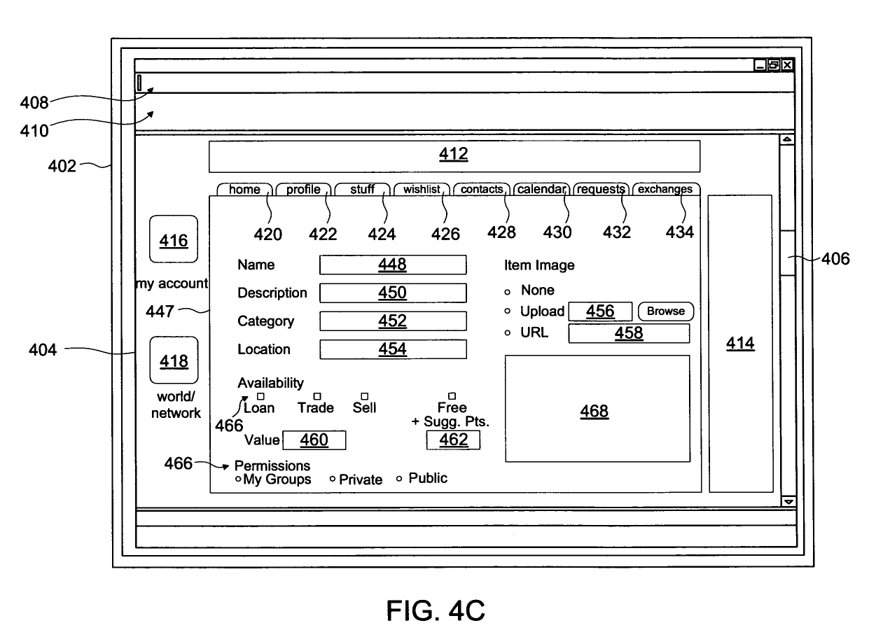

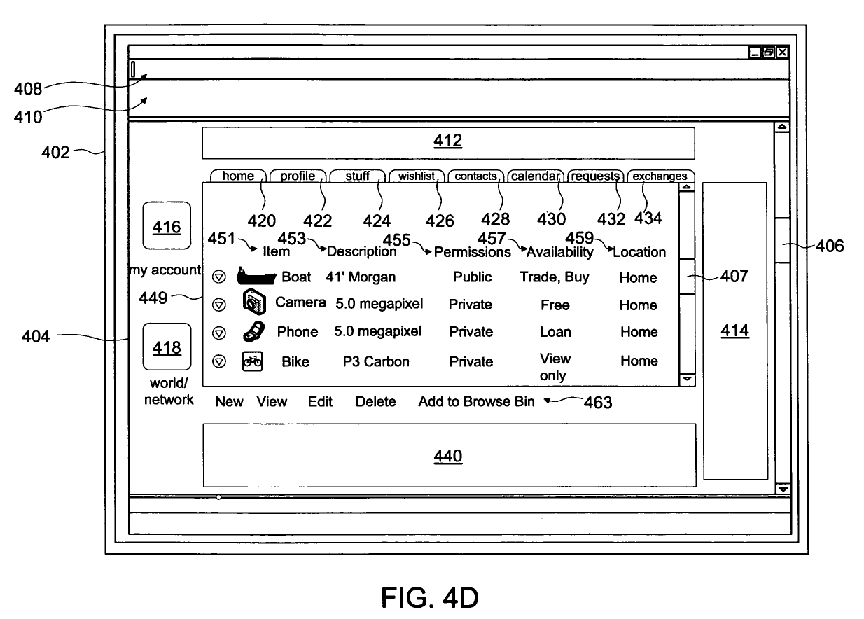

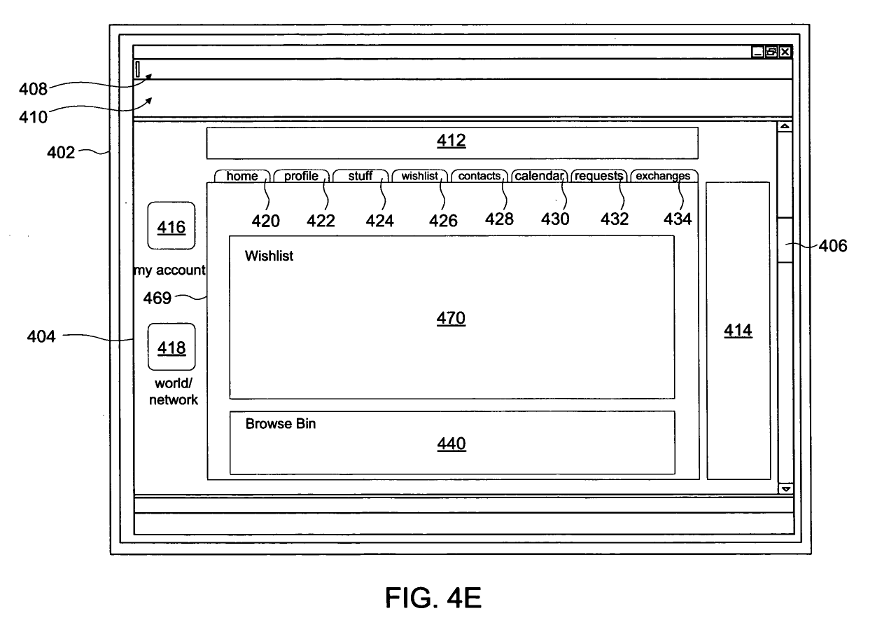

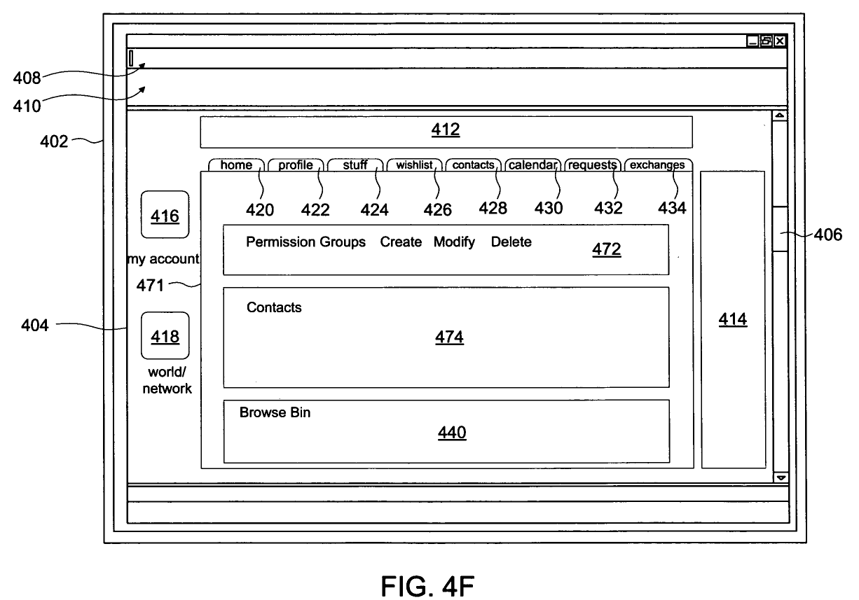

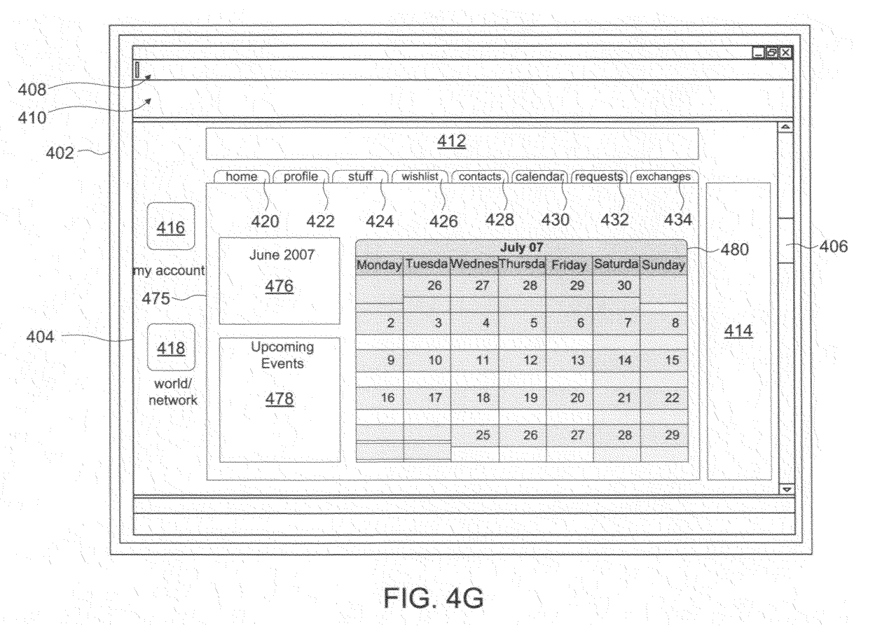

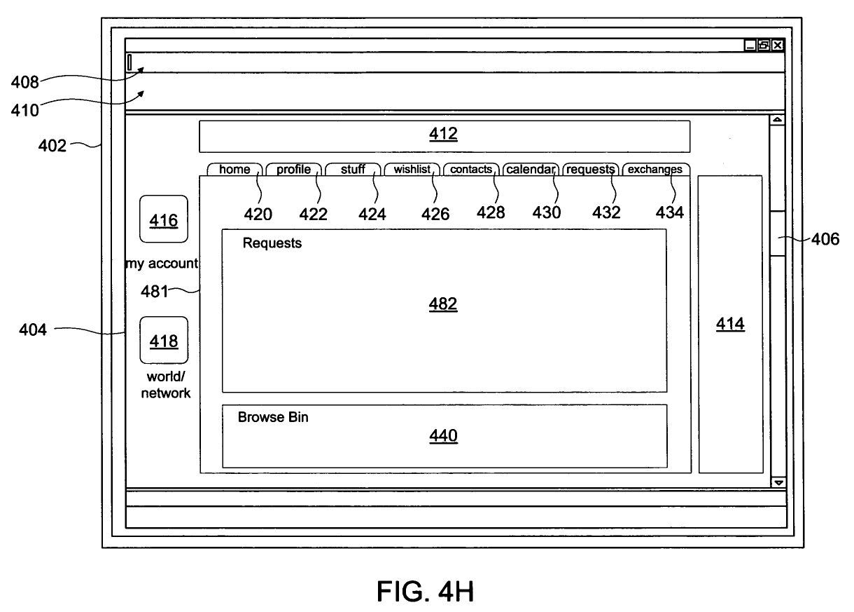

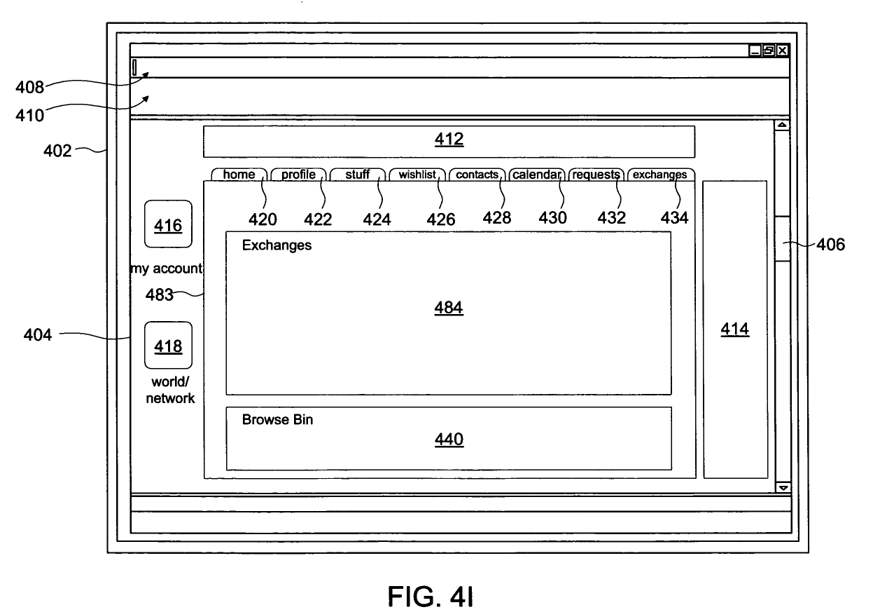

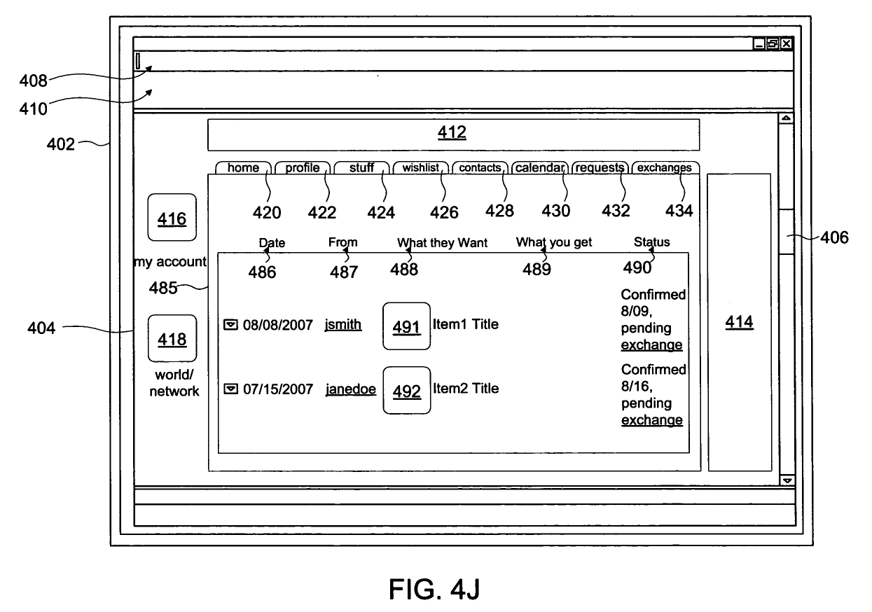

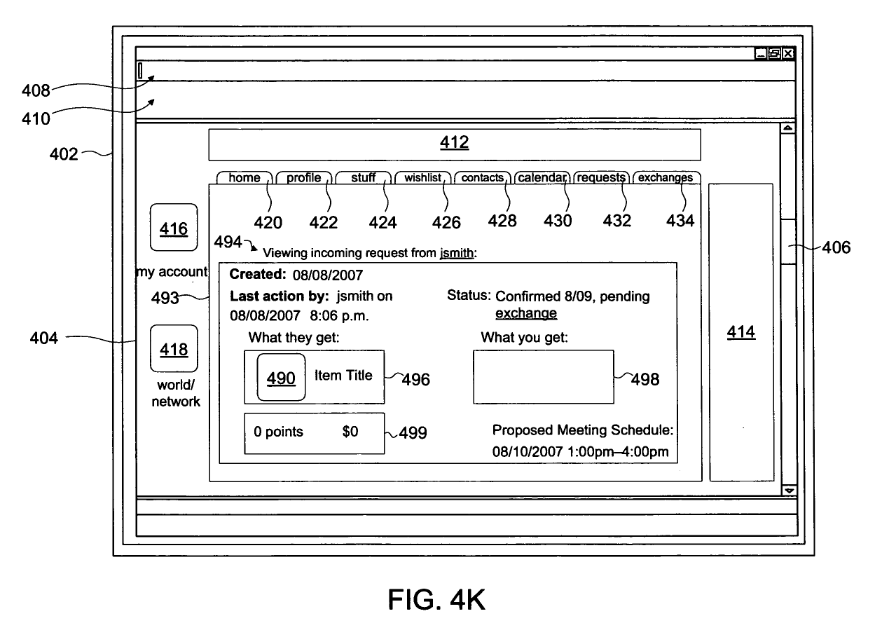

In some examples, item listings may be posted using a client that presents an interface that is configured to allow input of information related to an item, a personal inventory (i.e., a collection of items belonging to a given user), user, group, community, social network, or others. Item listings may be direct or indirectly posted to a system, application, interface, website, or other implementation of the functionality described herein. An item listing, privately viewed and managed on interface 110 by its owner, may be made publicly accessible on interfaces 124-128 by the owner by performing various actions including changing settings to the item listing on interface 110, and as described below in greater detail in connection with FIG. 4C. For example, item listings 122 may be provided using an interface coupled to a system or application that is configured to provide functionality for the above-described transactions. Further, a website may be rendered, delivered, displayed, or otherwise presented (“presented”) over the web using various types of data communication protocols such as TCP/IP (i.e., Transmission Control Protocol/Internet Protocol) and others. Different formats for rendering or delivering information associated with a system or application configured to implement the described techniques may also be used, including HTML, XML, WSDL, and others. In other examples, item listings may also be posted indirectly through other systems or applications that may have application architectures or features such as APIs (i.e., application programming interfaces) that allow item listings to be posted, retrieved and gathered on another website. Examples of indirect item listings such as those described above may include item listings 124-128. Item listings may be posted indirectly using various types of websites or endpoints. For example, server 116 may be used with database 118 and display 120 to input item listings, store information and data associated with an item listing or personal inventory, or administer a website that allows for item listings to be presented in a single website. Further, endpoints 104-108 may be used to provide item listings or personal inventory items indirectly using an auction website (i.e., auction item listing 128), an online marketplace (i.e., marketplace item listings 126), or an online classifieds website (i.e., classifieds items listings 124). Other types of direct and indirect item listings may be used with the techniques described herein to post and manage items and transactions involving these items. Once posted, items may be managed as part of a personal inventory, enabling users to engage in transactions such as those described above.

In some examples, system 100 and the above-listed elements may be described in various types of network topologies (e.g., client-server, peer-to-peer, WAN, LAN, and others) without limitation. When implemented, system 100 may be used to post, retrieve, and present item listings (e.g., item listings 122-128). System 100 may also be used to engage in social networking activities such as messaging, group participation, instant messaging, exchanging personal information (e.g., contact information, photos, images, virtual (i.e., non-physical, rendered) business or calling cards, blogging (i.e., write and post entries to a web log or “blog”), engaging in discussions related to topics involving personal inventories, items, or other subjects. Further, system 100 and the above-described elements may be implemented differently and are not limited to the examples provided.

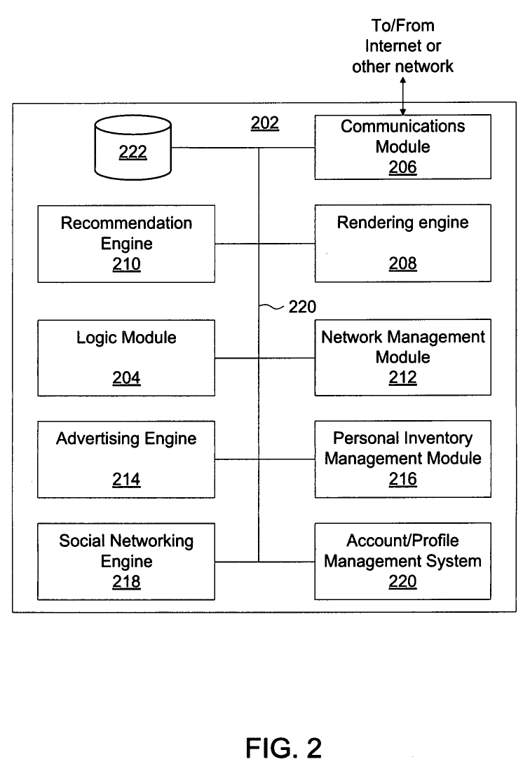

FIG. 2 illustrates an exemplary application for personal inventory management and item exchange. Here, application 202 includes logic module 204, communications module 206, rendering engine 208, recommendation engine 210, network management module 212, advertising engine 214, personal inventory management module 216, social networking engine 218, account/profile management system 220, and repository 222. In some examples, application 202 includes logic module 204, communications module 206, rendering engine 208, recommendation engine 210, network management module 212, advertising engine 214, personal inventory management module 216, social networking engine 218, account/profile management system 220, and repository 222 may be implemented as software, hardware, firmware, or a combination thereof. Further, application 202 may be implemented using one or more processors. In some examples, a single processor (i.e., server) may be used to compile and execute program code for application 202. In other examples, multiple servers may be used to compile and execute program code for application 202. Still further, application 202 may be implemented across a distributed set of processors that may be networked to each other. Any of the elements shown in application 202 may also be implemented apart (i.e., distributed) from each other or together with one, some, or all of the other elements shown (i.e., logic module 204, communications module 206, rendering engine 208, recommendation engine 210, network management module 212, advertising engine 214, personal inventory management module 216, social networking engine 218, account/profile management system 220, and repository 222). Application 202 is provided as an example of a general application architecture that may be used to implement the described techniques for personal inventory management and social networking. In other examples, application 202 and the above-described elements may be implemented differently.

Here, logic module 204 may be configured to provide control and management signals and data to communications module 206, category module 208, recommendation engine 210, network management module 212, advertising engine 214, personal inventory management module 216, social networking engine 218, account/profile management system 220, and repository 222 to implement personal inventory and item management, social networking, and other features and functions as described herein. Communications module 206 may be used to send or receive data between application 202 and its described elements or to other external systems and applications (e.g., an operating system, other applications or clients, other networked devices or systems, and the like). Rendering engine 208 may be used to interpret data and information managed by logic module 204 in order to generate a user interface for display on, for example, a client (e.g., clients 104-110).

In some examples, recommendation engine 210 may be configured to use data, information, past performance (i.e., the record of a given item's transaction history, how long an item has been loaned or borrowed, and others) and metrics (i.e., performance data associated with a given item's desirability, activity, or value, regardless of how the value of the item is determined, including how the item is chosen relative to other items, whether the item is requested with other items, frequency or infrequency, and other similar data) to generate a recommendation for an item. In other examples, recommendation engine 210 may be implemented differently and is not limited to any specific example or system.

Here, network management module 212 may be configured to access, request, retrieve, and send information associated with item listings and personal inventory data posted on various websites other than one generated by application 202. For example, an item listing on an auction website may be retrieved using network management module 212 and listed with other items posted on other types of websites (e.g., auction websites, classifieds, and others). As another example, network management module 212 may publish item listings on a website generated by application 202. Network management module 212 may also be configured to publish item listings on other websites not generated by application 202. In other examples, advertising module 214 may be used to access, request, retrieve, insert, target, or otherwise manage the use of online advertisements provided from repository 222 or from other sources (e.g., advertising networks, advertiser databases, and others).

Items may be managed using an interface (not shown) generated by application 202. Data presented in an interface generated by application 202 may be accessed, retrieved, and stored to repository 222 using personal inventory management module 216. In some examples, personal inventory management module 216 may be used to implement functions and features such as sending requests to sell, purchase, trade, exchange, borrow, or loan items in a personal inventory. In other examples, personal inventory management module 216 may also be used to manage items in an inventory. In still other examples, personal inventory management module 216 may also be used to allow users to create, post, and publish items. Other functions provided by personal inventory management module 216 may include tracking items, generating lists of items, categorizing or organizing items within a personal inventory, inviting other users to view items or to create accounts using application 202, sending messages (e.g., introductions), or engaging in transactions. In other examples, functions and features other than those described above may be implemented and are not limited to those described above. Social networking activities may be, in some examples, implemented by social networking module 218. Activities may include messaging (i.e., sending electronic mail (“e-mail”) messages) between users, establishing private or public groups or communities, generating invitations to users to become members of a group, adding or deleting e-mail addresses into application 202, importing e-mail addresses from other applications into application 202, linking to other users' items or profiles, and others. Further, logic module 204 may be used with social networking module 218 to implement algorithms that generate system-sent (i.e., by application 202) invitations between users. For example, one user may share a common interest in sailboats with another user. Logic module 204 may send a control signal or data to social networking module 218 to generate and send invitations to users sharing the common interest in sailboats. In other examples, social networking module 218 may be configured and implemented differently and is not limited to the examples described above.

Here, user accounts and profiles may be created and managed using account/profile module 220. In some examples, user account/profile module 220 allows users to create an account, list items, create and manage personal inventories, and input preferences for various transactions and activities. User account and profile information may be managed by account/profile module 220. Information such as user name, address, item name, description, system or user-assigned item values, and address may be input to account/profile module 220 and stored in repository 222. In other examples, less, more, or different information may be input to account/profile module 220 and stored in repository 222. Other types of information may be stored in repository 222, including data associated with personal inventories, item listings, metadata, links to item listings, scripts, and others. In other examples, application 202 and the above-described elements (i.e., logic module 204, communications module 206, rendering engine 208, recommendation engine 210, network management module 212, advertising engine 214, personal inventory management module 216, social networking engine 218, account/profile management system 220, and repository 222) may be implemented differently in design, function, operation, and implementation, and are not limited to those provided and described.

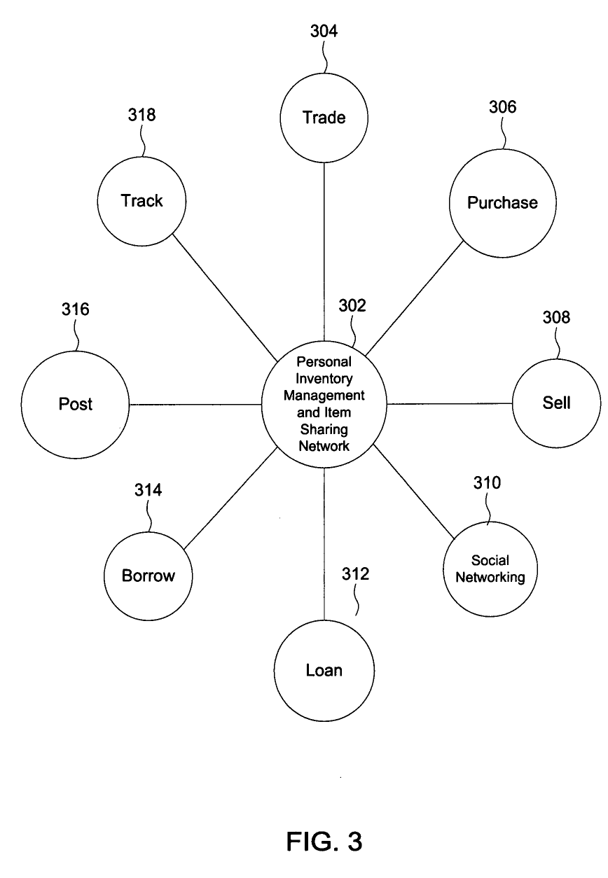

FIG. 3 illustrates exemplary categories of activities enabled by personal inventory management and item exchange. In some examples, personal inventory management and item sharing network 302 may be used to implement various types of activities, including trading 304, purchasing 306, selling 308, exchanging 310, lending 312, borrowing 314, posting 316, and tracking 318. The relative sizes of each circle representing a type of activity that may be performed has no significance or meaning with regard to the relative important or lack thereof of each type of activity or transaction. As used herein, “activity” and “transaction” may be used interchangeably without limitation. Here, trading 304, in some examples, may include transactions that enable a user to trade an item for another item. Purchasing 306 may describe commerce or related transactions that enable a user to buy an item. Alternatively, selling 308 may include transactions that allow a user to sell an item. Items may also be exchanged (i.e., exchanging 310) for other items or services or bartered between users. In other examples, activities may include loaning 312 items to another user. Users to whom items are lent may include friends, family, members of a social network (i.e., group, community, and the like), and others. In other examples, items may be loaned to other types of users. Items may also be borrowed by users (i.e., borrowing 314). Further actions that may be taken by a user including posting 316 and tracking 318. In other examples, more, fewer, or different types of activities apart from those shown may be implemented.

FIG. 4A illustrates an exemplary user interface for personal inventory management and item exchange. Here, interface 402 includes panel 404, scroll bar 406, tool bar 408, menu bar 410, advertisement spaces 412-414, buttons 416-418, tabs 420-434, and windows 435-440. In some examples, interface 402 may be configured as a home page for a user account for personal inventory management and social networking, as described herein. Tabs 420-434 and information associated with each tab is presented when button 416 (i.e., “my account”) is selected, depressed, or otherwise interacted with using an input device (e.g., mouse, touchpad, keyboard, scroll bar, tab button, and others). Advertising space may be provided for any organization, entity, or individual to place an advertisement that may be targeted by advertising module 214 (FIG. 2) for placement in one or both of advertisement spaces 412-414. As an example, advertising may be inserted into interface to generate revenue from advertising insertion fees, sponsorship fees, or other types of fees associated with various types of campaign placements. For example, some advertising campaigns may generate an amount of revenue that is determined based on the number of times an ad is served, “clicked through,” results in a transaction (i.e., if for an electronic commerce-based advertiser), or others. Different types, sizes, styles, layouts, campaigns, and other types of advertising may be used without limitation. Further, if space in panel 404 is constrained due to the amount of information presented in fields 448-466 or window 468, scroll bar 406 may be manipulated to view additional information below the bottom border of panel 404.

Here, window 436 may be used to present messages for a user or owner of an account when tab 420 (“home”) is selected. In some examples, window 438 may be configured to present tips and features, which may be information that is useful or contextually relevant to the given user or items owned or controlled by the user. Window 440 may be configured as a browse bin. As an example, a browse bin may refer to a graphical space, area, or portion of an interface 402 in which other on-screen elements may be placed. For example, a user may temporarily save an item for subsequent viewing, requesting, or other actions by “clicking and dragging” using an input device (e.g., a mouse) an icon or other graphical element representing the item into a browse bin. In some examples, items (i.e., icons, symbolic representations, graphical or other elements associated with an item) placed in a browse bin may be stored in repository 222 (FIG. 2) and later accessed and retrieved to present an aggregate display of items selected by a user. In other examples, when an item is placed in a browse bin (i.e., window 440), an icon, symbol, graphic, or other visual representation of an item may be stored for selection later by selecting the item from the browse bin and submitting a request for the item, as described below. In some examples, a user may place several item listings in a browse bin without requesting one of the items. A browse bin allows users to evaluate item listings without submitting requests for the item and having to repetitively search an inventory for the same interesting items. In other words, instead of continuously searching overall inventory to find interesting item listings, logging into an account, and identifying item listings of interest, a user can instead drag an item listing into the browse bin. As an example, a user may select a button or other on-screen element (e.g., “Request Item” button, or the like) to generate a message from the user's account to the item owner's account, notifying the owner of a user's request to borrow, purchase, trade, or otherwise engage in another transaction (e.g., as described above in connection with FIG. 3). As another example, several items may be placed into a browse bin before selecting one of the items to request.

In other examples, tabs 420-434 may be selected to change the appearance of window 435. For example, tab 424 may be selected to view items in the personal inventory for the account associated with login information provided by a user. A complete personal inventory, including options (e.g., add, delete, modify, publish, sell, and others) to manage the personal inventory, is not publicly accessible; other users may be permitted to see what is indicated for public viewing. In other words, interface 402 may be used to manage an inventory of personal items while providing limited or no publicly accessible viewing of the items in the inventory. In some examples, some items may be selected for public viewing or accessibility (i.e., “publicly accessible”) and others may be shown only to the owner of the personal inventory, using interface 402 as an inventory management tool. By providing a consolidated interface in interface 402 that allows inventory management and the ability to make publicly accessible items, which may be published on any number of marketplaces that are associated with the same or different domain (i.e., Internet addresses), improved and efficient item listing, publishing, and activity may be achieved.

When selected, each of tabs 420-434 may present a different panel in place of window 435. Alternatively, some elements of interface 402 may be retained in different panels when tabs 420-434 are selected. In other examples, templates may be generated and used to import information in various formats (e.g., XML) into interface 402. Further, buttons 416-418 may also be used to change the appearance (i.e., display or presentation) of interface 402, once selected. For example, button 416 may be selected by a user (i.e., by using a mouse or other user input device (e.g., touchpad)) and, once selected, the user's account profile is presented in panel 404. In other examples, when button 418 is selected, panel 404 changes appearance, presenting information associated with all items, accounts, or users in an item sharing network or marketplace (e.g., system 100 (FIG. 1)). Buttons 416-418 may also be implemented using other visual elements, such as hyperlinked text (i.e., text located anywhere within interface 502 and, when “clicked upon” results in directing a web browser or other Internet application to point to a given location or address), icons, symbols, tabs 420-434, widgets (i.e., on-screen elements having embedded functionality that causes another application, program, applet, or the like to be executed or launched when interacted with using an input device such as a computer mouse), or others. Further, any of the above-described elements and their associated location, function, layouts, or designs may be implemented using different techniques and are not limited to the visual appearances shown. In still other examples, interface 402 and the above-described elements may be varied in design, function, layout, style, or other aspects and are not limited to those shown and described.

FIG. 4B illustrates another exemplary user interface for personal inventory management and item exchange. Here, interface 402 includes panel 404, scroll bar 406, tool bar 408, menu bar 410, advertisement spaces 412-414, buttons 416-418, tabs 420-434, and windows 442-446. In some examples, interface 402, panel 404, scroll bar 406, tool bar 408, menu bar 410, advertisement spaces 412-414, buttons 416-418, tabs 420-434, and windows 442-446 may be implemented, designed, laid out, and function as described above in connection with FIG. 4A. Alternatively, interface 402, panel 404, scroll bar 406, tool bar 408, menu bar 410, advertisement spaces 412-414, buttons 416-418, and tabs 420-434 may be implemented, designed, laid out, and function differently.

Here, window 442 is presented when tab 422 (“profile”) is selected, providing windows 444 and 446 to display information such as statistics and blog entries, respectively. In some examples, window 442 may be a profile page that is presented when a user logs into system 100 (FIG. 1) and provides identification and authentication information. Once authenticated, a user's account may be accessed, retrieved, and displayed, including public profile information such as statistics (i.e., metrics that identify various aspects of a user's profile, such as how many times a given item was viewed, borrowed, loaned, or the like), blog entries, comment entries displayed in a comment posting area, and others. In some examples, blog or comment entries in window 446 may be entries that are provided by a user who is posting information for one or more other users to view and comment upon. Blog or comment entries may be tracked and archived using window 446 as a tool to present information to a user regarding his profile. In other examples, interface 402 and the above-described elements may be varied in design, function, layout, style, or other aspects and are not limited to those shown and described.

FIG. 4C illustrates yet another exemplary user interface for personal inventory management and item exchange. Here, interface 402 includes panel 404, scroll bar 406, tool bar 408, menu bar 410, advertisement spaces 412-414, buttons 416-418, tabs 420-434, window 447, fields 448-462, boxes 464-466, and window 468. In some examples, interface 402, panel 404, scroll bar 406, tool bar 408, menu bar 410, advertisement spaces 412-414, buttons 416-418, tabs 420-434, window 447, fields 448-462, boxes 464-466, and window 468 may be implemented, designed, laid out, and function as described above in connection with FIG. 4A. Alternatively, interface 402, panel 404, scroll bar 406, tool bar 408, menu bar 410, advertisement spaces 412-414, buttons 416-418, and tabs 420-434 may be implemented, designed, laid out, and function differently.

Here, tab 424 (i.e., “stuff”) may be selected to view items, create item listings, or to enter information about items (i.e., post an item listing) in a personal inventory. Information entered or presented in interface 402 may also be stored as metadata in repository 222 (FIG. 2). In some examples, metadata may be used to search for items based on category, name, type, access privileges, and others. In some examples, fields 448-462, boxes 464-466, and window 468 may be presented and used to post (i.e. list) an item on a website associated with interface 402. For example, fields 448-462 may be used to enter descriptive information regarding an item (e.g., name, description, category, location, value (field 460), or suggested number of points that the item is worth (i.e., field 462). In some examples, items may be recommended based on system or manually-determined recommendations that use software, hardware, circuitry, firmware, or a combination thereof to determine whether an item is appropriate for a given user's wants or needs. For example, a recommendation of an item may be made based on the popularity of the item in terms of the number of times it is requested, traded, borrowed, or loaned. As another example, users may be linked to each other based upon transactions involving a desired good, common interest, shared characteristic or attribute, or another parameter.

In other examples, an image of the item may be uploaded by entering a file name and path in field 456 and previewed in window 468. Likewise, if an image, description, or other file associated with the item is located on a website or at another location other than one associated with interface 402, then an address (e.g., HTTP, IP, domain, World Wide Web (www), and others) may be entered into field 458. The types of transactions that others may use to obtain the item may be indicated by selecting one of boxes 464.

In some examples, item listings and associated information (i.e., any type of information that may be related to an item, such as an item name, description, value, cost, price, location, status, and others) may be entered manually using interface 402 and the above-described elements. Alternatively, item listings and associated information may be imported automatically or semi-automatically using application 202. Further, item listings and associated information may be imported to application 202 from other applications or users. For example, radio frequency identification tags (RFID) may be used to tag various items and, when polled (i.e., when RF energy is propagated, RFID tags return an identification value or signal that allows items to be identified), item information may be imported into a database (e.g., repository 222) that stores and which may be later accessed to present information on interface 402. Other inventory management applications may be used with the techniques described herein to provide features such as item expiration dates (i.e., for perishable goods like foodstuffs and medicinal supplies), location tracking (e.g., using systems such as global positioning system (GPS) and others), theft notification and tracking of stolen goods, and others. Interface 402 and the above-described elements may be used to present information for one or more items, without limitation.

Permissions may also be set in terms of identifying the types of users who are allowed to view an item listing, including members of a group or community established by the user, private users (i.e., registered users), and public users (non-registered users who may access the above-described website publicly through the Internet or other data networks) by selecting one of boxes 466. In other examples, interface 402 and the above-described elements may be varied in design, function, layout, style, or other aspects and are not limited to those shown and described.

FIG. 4D illustrates an alternative exemplary user interface for personal inventory management and item exchange. Here, interface 402 includes panel 404, scroll bars 406-407, tool bar 408, menu bar 410, advertisement spaces 412-414, buttons 416-418, tabs 420-434, window 447, fields 448-462, boxes 464-466, and window 468. In some examples, interface 402, panel 404, scroll bar 406, tool bar 408, menu bar 410, advertisement spaces 412-414, buttons 416-418, tabs 420-434, window 449, headers 451-459, and menu 463 may be implemented, designed, laid out, and function as described above in connection with FIG. 4A. Alternatively, interface 402, panel 404, scroll bar 406, tool bar 408, menu bar 410, advertisement spaces 412-414, buttons 416-418, and tabs 420-434 may be implemented, designed, laid out, and function differently.

Here, tab 424 (i.e., “stuff”) may be selected to view items in a personal inventory. When selected, tab 424 presents window 449, which may be used to display item listings associated with a given inventory. Further, item listings may be created, edited, deleted, or modified in interface 402 and window 449. As described above in connection with FIG. 4C, item listings may be created and posted to a personal inventory, which may be viewed in, for example, window 449. An image, thumbnail, icon, avatar, text, or any other type of descriptive or visual representation may be displayed under header 451. Further, additional details or descriptive information may be listed under header 453. If permissions or other settings are configured by an item owner when creating an item listing, a permission status (e.g., “public,” “private,” “group only,” “family and friends,” or others) may be displayed under header 455. The availability (e.g., “trade,” “buy,” “loan,” “free,” and others) and the location (e.g., “home,” “work,” or another location) may be specified under headers 457-459, respectively. In other examples, more, fewer, or different information or data may be presented in window 449. Further, item listings presented in window 449 may be selected for various actions.

For example, the “bike” item listing may be selected, highlighted, or otherwise graphically indicated using, for example, a mouse or other input device (e.g., a keyboard). Once selected, an action may be performed by selecting one of the menu options from menu 463 (e.g., “new,” “view,” “edit,” “delete,” “add to browse bin,” and others). In some examples, an item does not need to be selected and, instead, an option may be selected to create, for example, a new item listing (i.e., selecting “new” from menu 463). More, fewer, or different options may be presented in menu 463 and are not limited to the examples shown and described. Further, options may be presented in formats, layouts, and styles other than menu 463 and are not limited to the examples shown and described. In other examples, interface 402 and the above-described elements may be varied in design, function, layout, style, or other aspects and are not limited to those shown and described.

FIG. 4E illustrates still another exemplary user interface for personal inventory management and item exchange. Here, interface 402 includes panel 404, scroll bar 406, tool bar 408, menu bar 410, advertisement spaces 412-414, buttons 416-418, tabs 420-434, window 440, and windows 469-470. In some examples, interface 402, panel 404, scroll bar 406, tool bar 408, menu bar 410, advertisement spaces 412-414, buttons 416-418, tabs 420-434, window 440, and windows 469-470 may be implemented, designed, laid out, and function as described above in connection with FIG. 4A. Alternatively, interface 402, panel 404, scroll bar 406, tool bar 408, menu bar 410, advertisement spaces 412-414, buttons 416-418, and tabs 420-434 may be implemented, designed, laid out, and function differently.

Here, when tab 426 is selected (i.e., when a user manipulates an input device (e.g., a mouse, touchpad, or others), a “wishlist” of items desired by a user appears in window 470. In some examples, various types of information may be presented in window 470, including the name, description, value, point value, location, status, desired transaction, and others. Further, window 470 may be configured for a user to add, delete, or modify wish list item listings or other information to customize a “wish list” to a specific user's preferences. For example, an item in a user's browse bin (i.e., window 440) may be added to a wishlist by clicking on an item icon, graphical element, or listing, and dragging it into window 470. In some examples, “clicking” and “dragging” refers to the manipulation of a computer mouse using buttons and position indicators configured within the mouse to allow users to move an on-screen element (e.g., an arrow, pointer, hand, or others). Alternatively, an item in window 470 may be removed by dragging it into a browse bin (i.e., window 440). In other examples, interface 402 and the above-described elements may be varied in design, function, layout, style, or other aspects and are not limited to those shown and described.

FIG. 4F illustrates a further exemplary user interface for personal inventory management and item exchange. Here, interface 402 includes panel 404, scroll bar 406, tool bar 408, menu bar 410, advertisement spaces 412-414, buttons 416-418, tabs 420-434, window 440, and windows 471-474. In some examples, interface 402, panel 404, scroll bar 406, tool bar 408, menu bar 410, advertisement spaces 412-414, buttons 416-418, tabs 420-434, window 440, and windows 471-474 may be implemented, designed, laid out, and function as described above in connection with FIG. 4A. Alternatively, interface 402, panel 404, scroll bar 406, tool bar 408, menu bar 410, advertisement spaces 412-414, buttons 416-418, and tabs 420-434 may be implemented, designed, laid out, and function differently.

Here, windows 472-474 are presented in panel 404 when tab 428 (i.e., “contacts”) is selected. In some examples, window 472 may be configured to present options for setting permissions for a given user's preferences. For example, a user may wish to create a group and provide permissions as to whether users within the group may view (i.e., given privileges or permissions to allow viewing) item listings or other information within the users' personal inventory. As another example, groups may also create, modify, or delete items owned or operated by the group. When requested by group members, item requests may be accepted or rejected by group administrators using techniques substantially similar to those described herein. In other examples, different types of item permissions may be specified, such as whether a user may view, request, purchase, trade, borrow, or engage in other transactions. In other examples, window 474 may be presented to view users or others listed in a contacts database associated with a given user's account. For example, other registered users of system 100 (FIG. 1) who have established an account and profile may be listed in window 474. As another example, any type of user, regardless of whether an account or profile has been established, may be listed in window 474. In other words, other individuals may be listed in window 474, regardless of whether they are a registered user of application 202 (FIG. 2). User information such as name, user ID, e-mail address, street address, mail address, telephone number, age, sex, number of transactions performed with items in the user's personal inventory, rating (i.e., creditworthiness, trustworthiness, and the like, regardless of whether annotated using subjective text-based comments or an objective numerical, point value, or other type of rating system), and other information may be presented in window 474. The organization of the information in windows 472-474 may be presented in any order or layout without limitation. In other examples, interface 402 and the above-described elements may be varied in design, function, layout, style, or other aspects and are not limited to those shown and described.

FIG. 4G illustrates an additional exemplary user interface for personal inventory management and item exchange. Here, interface 402 includes panel 404, scroll bar 406, tool bar 408, menu bar 410, advertisement spaces 412-414, buttons 416-418, tabs 420-434, windows 475-478, and calendar 480. In some examples, interface 402, panel 404, scroll bar 406, tool bar 408, menu bar 410, advertisement spaces 412-414, buttons 416-418, tabs 420-434, windows 475-478, and calendar 480 may be implemented, designed, laid out, and function as described above in connection with FIG. 4A. Alternatively, interface 402, panel 404, scroll bar 406, tool bar 408, menu bar 410, advertisement spaces 412-414, buttons 416-418, and tabs 420-434 may be implemented, designed, laid out, and function differently.

Here, windows 476-478 and calendar 480 may be presented when tab 430 is selected. In some examples, calendar 480 may present a monthly view, as shown here. In other examples, calendar 480 may present daily, weekly, quarterly annual, combined (e.g., daily and monthly, weekly and monthly, and the like), or multiple calendar (e.g., more than one day, week, month, year, or the like are presented) views. Further, reminders to return borrowed items may be automatically, semi-automatically, or manually added to calendar 480. Still further, meeting times and locations to exchange items may be automatically, semi-automatically, or manually added to calendar 480. In still other examples, calendar 480 may be configured and presented differently. Here, window 476 may be used to present items or events occurring or having relevance to the period of time represented by calendar 480. Likewise, window 478 may be configured to present a list of events or items that may be occurring or have some sort of relevance in the future. The time period for determining what items or events to present in windows 476-478 may be varied and are not limited to any specific example. Further, interface 402 and the above-described elements may be varied in design, function, layout, style, or other aspects and are not limited to those shown and described.

FIG. 4H illustrates another additional exemplary user interface for personal inventory management and item exchange. Here, interface 402 includes panel 404, scroll bar 406, tool bar 408, menu bar 410, advertisement spaces 412-414, buttons 416-418, tabs 420-434, window 440, and windows 481-482. In some examples, interface 402, panel 404, scroll bar 406, tool bar 408, menu bar 410, advertisement spaces 412-414, buttons 416-418, tabs 420-434, window 440, and windows 481-482 may be implemented, designed, laid out, and function as described above in connection with FIG. 4A. Alternatively, interface 402, panel 404, scroll bar 406, tool bar 408, menu bar 410, advertisement spaces 412-414, buttons 416-418, and tabs 420-434 may be implemented, designed, laid out, and function differently.

In some examples, window 482 may be presented when tab 432 is selected. Window 440 may be presented to provide user access to a browse bin, as described above. As an example, requests for various items may be presented in window 482. In other examples, a user may indicate specific items that she wishes to exchange for her item. For example, if a user indicates a specific item that she wishes to exchange for her item, application 202 (FIG. 2) may generate a message to the owner of the desired item indicating a request to exchange items by selecting an item (e.g., checking a box, clicking on a radio button, or entering another type of indication of selection). As described herein, items may be added to any window using these described techniques. Further, when a request for an item is entered, items may be placed in window 482. Requests presented in window 482 may be organized using various techniques. For example, items may be listed in a temporal (e.g., when an item was requested, from oldest to most recent requests or from most recent to oldest requests), categorical (i.e., based on a category associated with the requested item), or manually-determined (i.e., the appearance of each item may be manipulated using a mouse or other input device) order. In other examples, items may be organized using various types of data structures (e.g., matrices, grids, columns, rows, or others) or any type of graphical appearance (e.g., font, color, style, and others) without limitation. In still other examples, the appearance of items requested and presented in window 482 may be varied and is not limited to the examples shown and described. Further, interface 402 and the above-described elements may be varied in design, function, layout, style, or other aspects and are not limited to those shown and described.

FIG. 4I illustrates a further additional exemplary user interface for personal inventory management and item exchange. Here, interface 402 includes panel 404, scroll bar 406, tool bar 408, menu bar 410, advertisement spaces 412-414, buttons 416-418, tabs 420-434, window 440, and windows 483-484. In some examples, interface 402, panel 404, scroll bar 406, tool bar 408, menu bar 410, advertisement spaces 412-414, buttons 416-418, tabs 420-434, window 440, and windows 483-484 may be implemented, designed, laid out, and function as described above in connection with FIG. 4A. Alternatively, interface 402, panel 404, scroll bar 406, tool bar 408, menu bar 410, advertisement spaces 412-414, buttons 416-418, and tabs 420-434 may be implemented, designed, laid out, and function differently.

In some examples, when tab 434 (i.e., “exchanges”) is selected, window 484 is presented. A user may view item listings in her personal inventory, using window 484, that are scheduled for exchanges with other users. Likewise, a user may also view items requested from other users in window 484. Window 484 may also be configured to allow users to schedule exchanges for items (i.e., after accepting an item request) with other users who have requested an item. Further, past exchanges may also be viewed in window 484, which may be a consolidated listing of scheduled and past (i.e., completed) exchanges. When exchanges for an item are completed (i.e., confirmed, accepted, or the like), the items may be moved (i.e., removed from display on window 449 (FIG. 4D) and displayed as part of a completed exchange in window 484. In other words, when requests are accepted, window 484, which may be configured as an “Exchange Bin,” enables users to schedule meeting times, places, and confirm (i.e., indicate that an exchange, transaction, sale, purchase, return, or other activity has occurred) actions. In some examples, an image, icon, or other graphical element may be shown with a description of the item, which may also include information such as categories or types of items that the user exchanges for her item. Regardless, interface 402 and the above-described elements may be varied in design, function, layout, style, or other aspects and are not limited to those shown and described.

FIG. 4J illustrates an exemplary status user interface. Here, interface 402 includes panel 404, scroll bar 406, tool bar 408, menu bar 410, advertisement spaces 412-414, buttons 416-418, tabs 420-434, window 485, headers 486-490, and icons 491-492. In some examples, interface 402, panel 404, scroll bar 406, tool bar 408, menu bar 410, advertisement spaces 412-414, buttons 416-418, tabs 420-434, window 485, headers 486-490, and icons 491-492 may be implemented, designed, laid out, and function as described above in connection with FIG. 4A. Alternatively, interface 402, panel 404, scroll bar 406, tool bar 408, menu bar 410, advertisement spaces 412-414, buttons 416-418, and tabs 420-434 may be implemented, designed, laid out, and function differently.

Here, window 485 may be presented to display information associated with requests for one or more items within a personal inventory. For example, requests may be received from different users (e.g., “jsmith” and “janedoe”) on different dates. As an example, a pull-down menu may be implemented to provide additional options for managing items in a personal inventory. In other examples, different user interface elements may be used to provide substantially similar functionality.

In some examples, requests may be presented with the date (i.e., that the request was received or sent), the sending user name (i.e., account name, endpoint name, or the like), items requested (i.e., “What they want”), items offered in exchange for the requested item (i.e., “What you get”), and a status of the activity (e.g., exchange, purchase, borrow, trade, sell, and others). As an example, a status may be presented when an item listing is initially posted. When an offer is made on an item, a status may change when the offer is presented (i.e., the requesting or offering user confirms the offer and enables the transmission of the offer across, for example, system 100 (FIG. 1)). Further, if an offer is accepted, the status may change again. For example, when an offer to buy an item is presented (i.e., displayed) by an offering user, a status may change to “sale pending.” If the offer is accepted by the owner of the requested item, the status may change again to “sold.” Offers may be, in some examples, accepted, rejected, modified, countered, or subjected to other actions by a receiving user. Further, a user may modify, counter, delete, or perform other actions associated with an offer. Offers may also be sent under a user name or anonymously. Further, when transactions, actions, or other activity are confirmed (i.e., accepted by a user), the status may change and the personal inventory may be updated to reflect the latest status. In some examples, status changes may be viewed by users. For example, if an item is in the midst of an exchange that has not been confirmed, a status may be presented. When the exchange is confirmed, the status may change along with an update to the status of the item owner's inventory. Other users may be able to see various status indicators that, for example, an item exchange is in progress, preventing further offers or counter offers from being presented to the item owner. Further, when an item exchange is confirmed, the status of an item may change to indicate that the item is no longer available for purchase, trade, exchange, or the like. Still further, status changes may also automatically, semi-automatically, or trigger (i.e., send a message or reminder to a user account) updating of a personal inventory. In other examples, status changes may be implemented differently.

Icons 491-492 may be graphical elements (e.g., pictures, images, thumbnails, avatars, symbols, or other visual elements) used to represent the item. Icons 491-492 may be thumbnails of, for example, a book cover, a painting, a photograph of the requested item or object, and others. Icons 491-492 may be varied and are not limited to the examples provided. As an example, the types of information presented (i.e., as shown by headers 486-490) may be varied and laid out differently and are not limited to the examples shown. Further, more, fewer, or different types of actions or activities may be presented in window 485. For example, user names presented in a column under header 487 (i.e., “From”) may be link-enabled (i.e., presented with an embedded hyperlink that, when “clicked upon” or selected using an input device (e.g., a mouse, keyboard, or others) points a web or Internet browsing application to a given destination, address, computer, or location). As another example, users may select hyperlinked text that yields additional information, such as a status or explanation thereof. Still further, interface 402, window 485, and the above-described elements may be varied in design, function, layout, style, or other aspects and are not limited to those shown and described.

FIG. 4K illustrates another exemplary status user interface. Here, interface 402 includes panel 404, scroll bar 406, tool bar 408, menu bar 410, advertisement spaces 412-414, buttons 416-418, tabs 420-434, window 493, icon 490, header 494, and windows 496-499. In some examples, interface 402, panel 404, scroll bar 406, tool bar 408, menu bar 410, advertisement spaces 412-414, buttons 416-418, tabs 420-434, window 493, icon 490, header 494, and windows 496-499 may be implemented, designed, laid out, and function as described above in connection with FIG. 4A. Alternatively, interface 402, panel 404, scroll bar 406, tool bar 408, menu bar 410, advertisement spaces 412-414, buttons 416-418, and tabs 420-434 may be implemented, designed, laid out, and function differently.

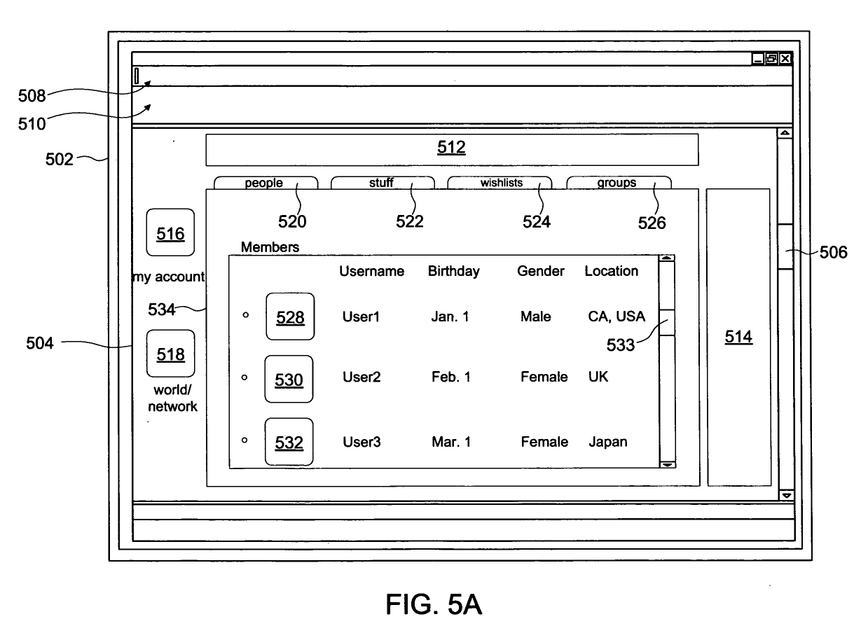

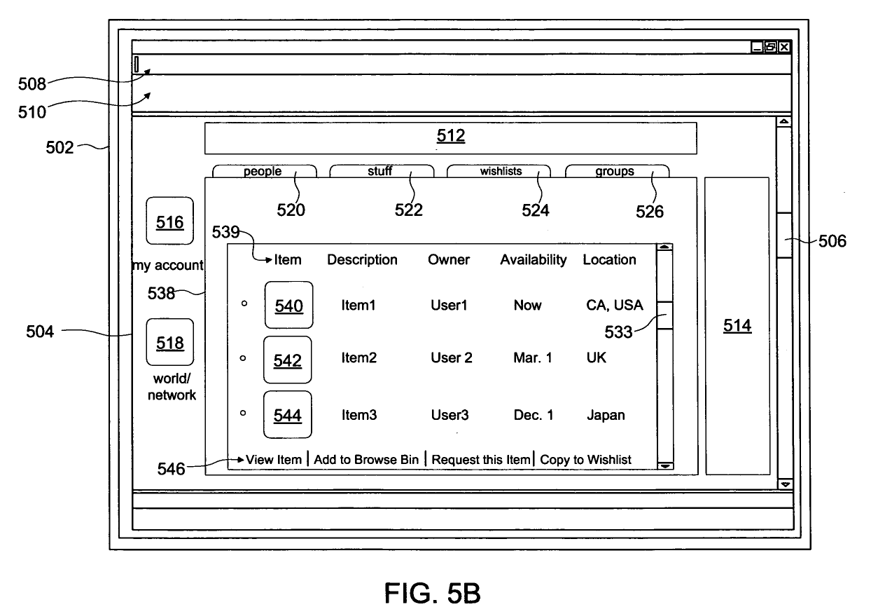

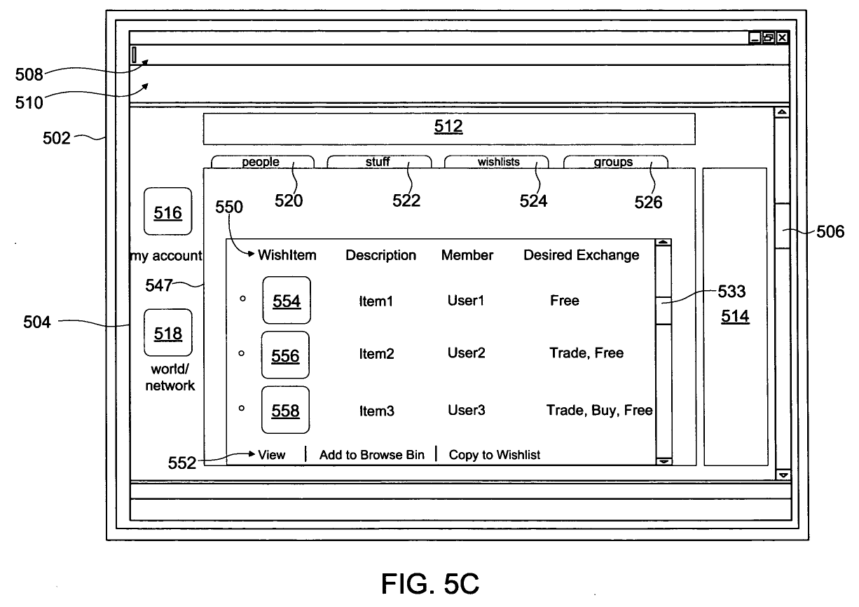

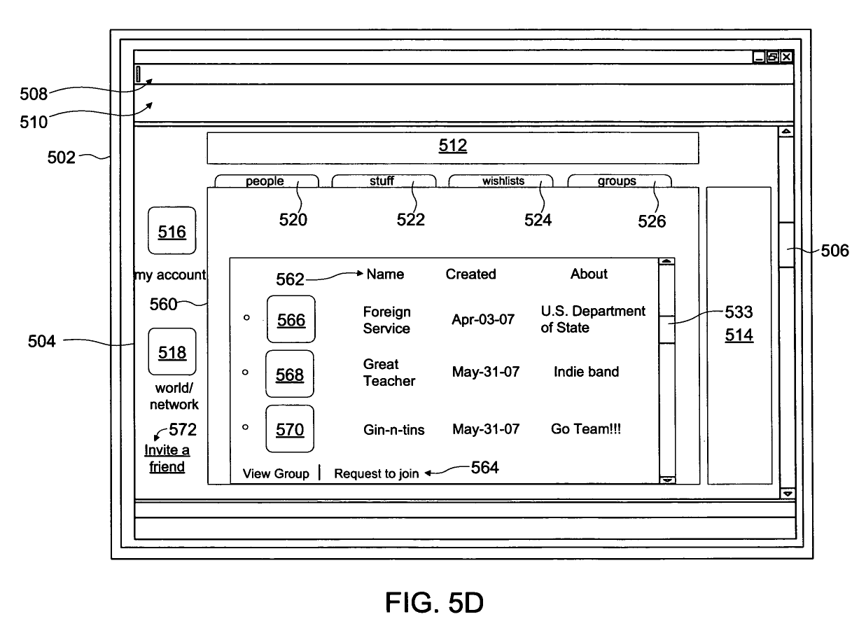

Here, window 493 may be used to present information associated with a given offer, counter offer, or the like. In some example, information (e.g., when a request was created, the last action taken with regard to offers to exchange the item, status, and a proposed meeting scheduled to exchange an item, and the like) may be presented as text within window 493. When a request is selected by, for example, interacting with icon 491-492 (FIG. 4J), additional details regarding a given offer may be presented. For example, an item listing may be created or edited to indicate that an item may be publicly viewed and available for purchase, loan, “free,” or trade (i.e., exchanges for other items, money, points, or a combination thereof). Subsequently, other users may request an item by selecting the item listing in window 538 in FIG. 5B and selecting, for example, “Request this Item,” which submits a request that the item owner may receive and view within window 485. Clicking on the icon representing the request may display a description of the requested item in window 496. Further, an item may be requested in exchange for a point value or price which may be provided in window 499. Status information associated with an item (e.g., an item represented by icon 490) may be presented to indicate the status or location of the item. Other information may also include the status of a transaction, activity, or action affecting the item. Examples of transactions, activities, or actions that may be managed by system 100 (FIG. 1) resulting in rendering interface 402 include presenting calendars, windows configured to receive information for arranging an exchange or other type of “deal” (i.e., transaction, activity, action), location, date or time of an exchange, reminders for various purposes, negotiating meetings to conduct a transaction, activity, or action. In still other examples, different techniques for presenting details and information associated with an offer may be presented in window 493 and is not limited to the examples shown and described above.

FIG. 5A illustrates an alternative exemplary user interface for personal inventory management and item exchange. Here, interface 502 includes panel 504, scroll bar 506, tool bar 508, menu bar 510, advertising spaces 512-514, buttons 516-518, tabs 520-526, window 527, icons 528-532, scroll bar 533, and header 534. In some examples, interface 502 is presented when button 518 is selected, providing information associated with other users and their items, but indicated as being associated with a given user (i.e., indicated as being part of a user's “world” or “network,” as indicated by the text (“world/network”) under button 518). In other examples, different descriptions, labels, or names other than “world” or “network” may be used and are not limited to the illustrative examples presented. Buttons 516-518 may also be implemented using other visual elements, such as hyperlinked text (i.e., text located anywhere within interface 502 and, when “clicked upon” results in directing a web browser or other Internet application to point to a given location or address), icons, symbols, widgets (i.e., on-screen elements having embedded functionality that causes another application, program, applet, or the like to be executed or launched when interacted with using an input device such as a computer mouse), or others. Further, any of the above-described elements and their associated location, function, layouts, or designs may be implemented using different techniques and are not limited to the visual appearances shown.

When tab 520 (i.e., “people”) is selected, window 527 may be configured to present information and data associated with various users. For example, icons 528-532 are presented, which may be any type of graphical element (e.g., icon, symbol, picture, image, avatar, or others) used to represent the given user (e.g., User1, User2, User3, and the like). Other information such as birthday, gender, and physical location may also be specified, as indicated by header 534. If the list of users exceeds the display space provided in window 527, scroll bar 533 may be manipulated using an input device (e.g., a mouse) to scroll up or down through a list of users. In other examples, interface 502 and the above-described elements may be varied in design, function, layout, style, or other aspects and are not limited to those shown and described.

FIG. 5B illustrates another alternative exemplary user interface for personal inventory management and item exchange. Here, interface 502 includes panel 504, scroll bar 506, tool bar 508, menu bar 510, advertising spaces 512-514, buttons 516-518, tabs 520-526, scroll bar 533, window 538, header 539, icons 540-544, and footer 546. In some examples, when tab 522 (i.e., “stuff”) is selected, window 538 is presented. Tab 522 may be entitled using any type of descriptive header or text and is not limited to the examples shown (i.e., “stuff”). Header 539 may be used to organize item, description, owner, availability, and location information. As an example, items may be indicated using icons 540-544, followed by an item description (e.g., text or graphically-based), owner name, time of availability (e.g., “Now,” “Mar. 1,” “Dec. 1,” or others), and location. In other examples, different types of information associated with items indicated by icons 540-544 may also be used.

In some examples, icons 540-544 may be implemented using any type of on-screen or displayed content, including static images, files, pictures, audio, video, or a combination thereof. In other examples, footer 546 may be presented to provide a menu of options that a user may select in association with a given item. For example, by clicking on a radio button (i.e., one of the hollow circles shown to the left of each of icons 540-544), a user may choose to request the indicated option by clicking on the “Request this Item” link. Clicking on menu options presented in footer 546, enables various actions to be taken with regard to items chosen from the list presented above in window 538. The types of options presented in footer 546 may be varied and are not limited to those shown. Still further, if a list of items populated in window 538 exceeds the available display space provided in window 538, scroll bar 533 may be manipulated to scroll up or down the list of items presented in window 538. In other examples, window 537 may be rendered to persistently display header 539 and footer 546. In other words, when scroll bar 533 is manipulated, header 539 and footer 546 remain stationary. In other examples, interface 502 and the above-described elements may be varied in design, function, layout, style, or other aspects and are not limited to those shown and described.

FIG. 5C illustrates yet another alternative exemplary user interface for personal inventory management and item exchange. Here, interface 502 includes panel 504, scroll bar 506, tool bar 508, menu bar 510, advertising spaces 512-514, buttons 516-518, tabs 520-526, scroll bar 533, window 547, header 550, footer 552, and icons 554-558. In some examples, when tab 524 (i.e., “wishlists”) is selected, window 547 is presented, providing information associated with items listed in users' “wish lists” or list of items desired for purchase, trade, exchange, or other transactions. As an example, icons 554-558 may be graphical, symbolic, textual, or other types of on-screen elements used to represent a given item. As indicated by header 550, various types of information may be presented with icons 554-558, including a description of each item, the member ID (e.g., “User1,” “User2,” “User3,” and the like) of the item owner, and the types of transactions (e.g., “Free,” “Trade, Free,” “Trade, Buy, Free,” and others) that are available for the item. In other examples, different types of information may also be presented. While information is presented in window 547 using a row-and-column or matrix-type format, other formats may be used to present wishlist information. Items displayed “below the fold” or not presented on the visible portion of window 547 may be viewed by scrolling using scroll bar 533 to view other items items. Further, when an item is selected (e.g., clicking on a radio button to the left of icons 554-558), options may be selected from footer 552 (e.g., “View,” “Add to Browse Bin,” “Copy to Wishlist,” and others). More, fewer, or different options may be added to footer 552 and are not limited to those shown. Further, interface 502 and the above-described elements may be varied in design, function, layout, style, or other aspects and are not limited to those shown and described.

FIG. 5D illustrates still another alternative exemplary user interface for personal inventory management and item exchange. Here, interface 502 includes panel 504, scroll bar 506, tool bar 508, menu bar 510, advertising spaces 512-514, buttons 516-518, tabs 520-526, scroll bar 533, window 560, header 562, footer 564, icons 566-570, and invitation link 572. In some examples, application 202 may be configured to generate an interface used to create, delete, modify, or otherwise manage user groups or communities. Further, interface 502 may be used to present information associated with various types of social networking activities, such as messaging, exchanging contact information (e.g., name, e-mail address, telephone number, mailing address, sex, age, birthday, occupation, activities, preferences, likes/dislikes, sexual orientation, political and professional affiliations, religious background, memberships, and other types of information). Information exchanged while engaging in social networking activities across a data network may be used to establish personal, professional, commercial, political, religious or other types of relationships regardless of whether an item exchanged is involved. In other examples, social networking activities such as those described above may be used to develop relationships between users in order to establish a degree of security or emotional comfort prior to engaging in a transaction. Further, social networking activities may also be performed individually (i.e., user-to-user) or among groups of users.

Here, when tab 526 (i.e., “groups”) is selected, window 560 is presented, which provides information, options, and other features associated with establishing and managing groups of users that are identified or create by a given user or group of users. In some examples, icons 566-570 may be graphical, symbolic, textual, or other types of on-screen elements used to represent a given group of users (e.g., “Foreign Service,” “Great Teacher,” “Gin-n-tins,” and others). Icons 566-570, invitation link 572, and other on-screen elements may also be implemented to include links, scripts, or other functionality that, when clicked upon, may lead to other actions (e.g., opening a web browser, point to another destination or location, open a dialog box, launch another application, program, or executable file, and others). In some examples, when invitation link 572 is used, an invitation may be sent to a user to invite them to join (i.e., create an account and profile). In other examples, an invitation may be sent by group administrators to invite users to join a group. As an example, a separate window (not shown) may also be selected and presented that is configured to present one or more fields for entering information, parameters, or data associated with group administration functions. For example, a group administrator may select a tab (not shown) that presents a window displaying members of the group, options to remove members, options to accept or deny new membership requests, and various parameters associated with the group. In some examples, a group administration window may be presented to users designated as group administrators. In other examples, a group administration window may not be presented to users who are not group administrators. Functions that may be presented on a group administration window may include a field for entering an e-mail address or user name to which an invitation (e.g., via e-mail) may be sent in order to invite a user to join a group. Other functions may include entering control parameters that designate which users have group administration rights. Still other functions may include identifying information or data (e.g., item listings) that group members are able to request or precluding non-members from viewing. In still other examples, any type of graphical user interface window or display may be presented, including those substantially similar to those shown and described in FIGS. 4A-4H, and are not limited to any specific display, configuration, layout, style, function, or structure.

In some examples, when invitation link 572 is selected (i.e., clicked upon), digital data is encoded into an electronic request (e.g., an e-mail) that is sent to invite a friend (i.e., another account with an e-mail account that is configured to receive an e-mail invitation) to create, configure, and establish an account with system 100. In some examples, a group profile page (not shown) may also be provided, presenting information, fields, and other areas for viewing information associated with the group. For example, a group profile page may have an “admin” tab that allows users to select a button, link, or other on-screen element or mechanism to allow users to join a group. In other examples, a group profile page may be implemented, presented, or otherwise displayed differently and is not limited to the examples described above.

Also shown in FIG. 5D are header 562 and footer 564, the latter of which includes link-enabled options that a user may select for one or more of the groups listed in window 560. For example, a group associated with icon 568 may be selected by clicking on the radio button to the left of icon 568. Once selected, the group and any associated activity (e.g., messaging, blog entries, discussions, chats, instant messaging exchanges, and others) may be viewed by selecting the option “View Group” in footer 564. As described above, any graphical user interface window or display may be presented to show an interface configured to provide various fields, parameters, actions, or other information associated with group administration. In some examples, windows substantially similar to those described above may be used to implement and present group administration functions and are not limited to those shown and described. Alternatively, some groups may be managed or moderated by other users and a request to join may be sent by selecting the option “Request to join” in footer 564. In still other examples, more, fewer, or different options may be presented in footer 564.

Here, groups may be identified using different types of information. For example, groups may be identified by icons 566-568, which may be artwork such as graphical, symbolic, textual, or other types of on-screen elements. As reflected in header 562, groups may also be identified by attributes, characteristics, and other information such as name, the date the group was created, or any notes about the group (i.e., “About”). In yet other examples, more, fewer, or different attributes, characteristics, or information may be used to identify groups in window 560 and are not limited to those shown and described. Further, interface 502 and the above-described elements may be varied in design, function, layout, style, or other aspects and are not limited to those shown and described.

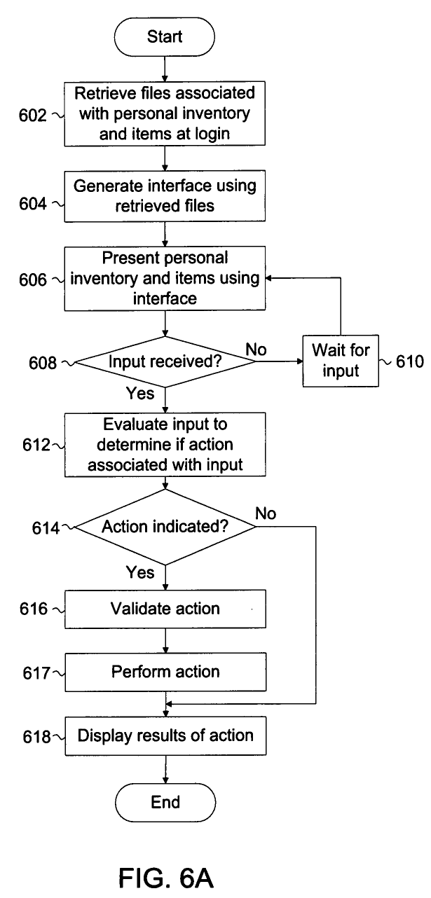

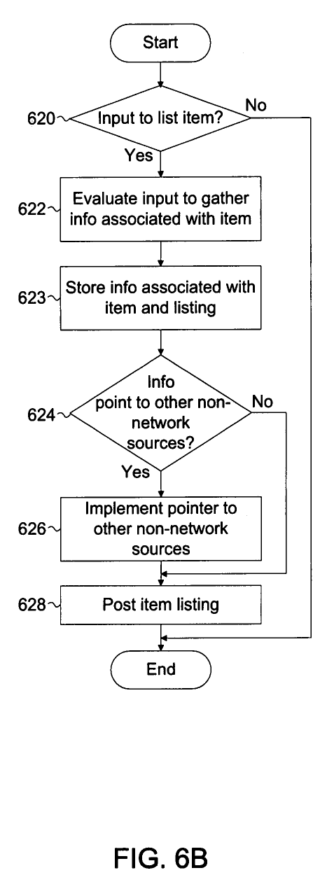

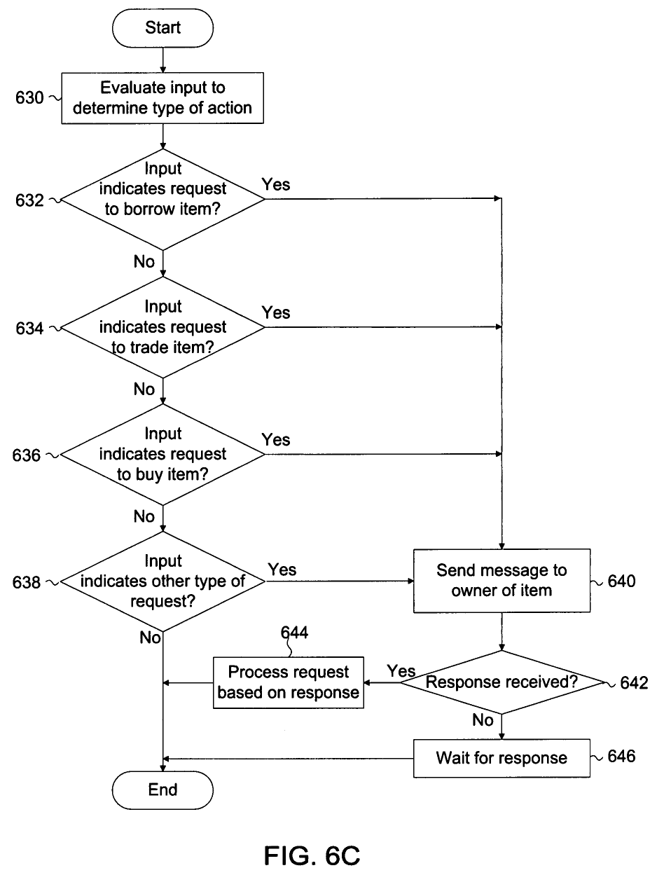

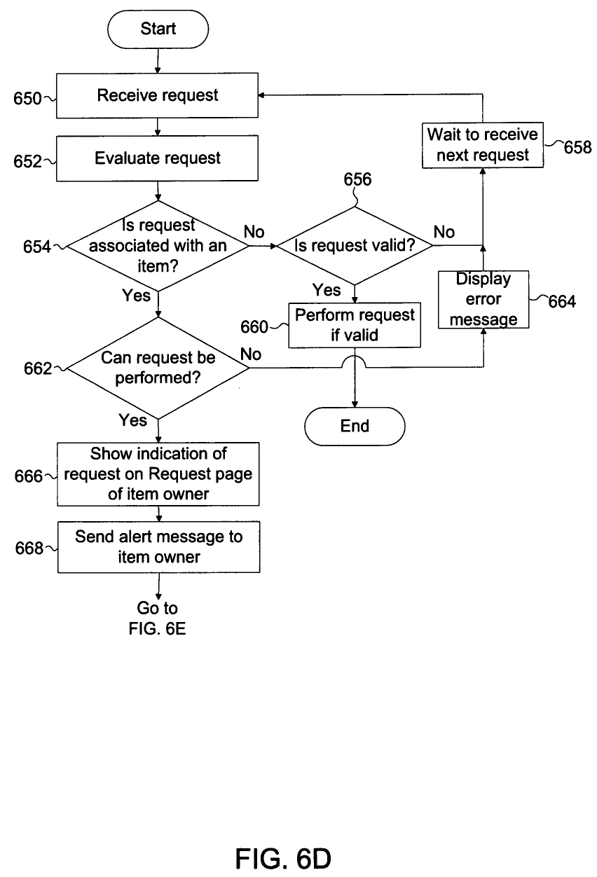

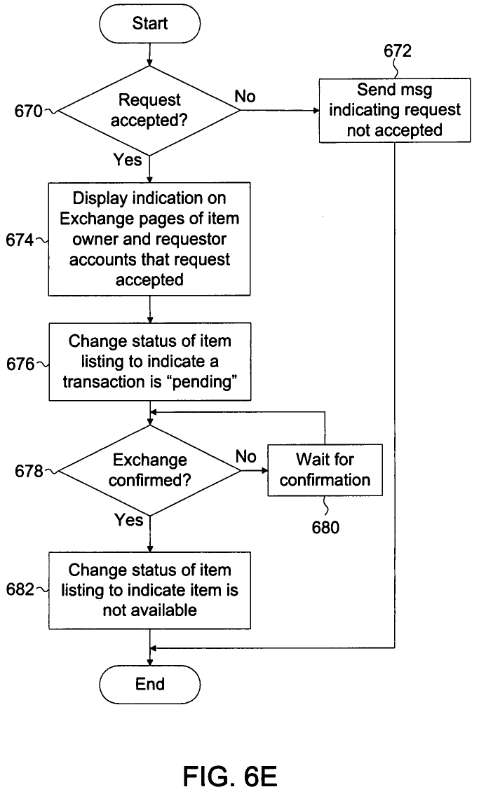

FIG. 6A illustrates an exemplary process for personal inventory management and item exchange. Here, one or more files are retrieved that are associated with personal inventory and items within it when a login (i.e., a user ID, password, digital certificate, or other types or forms of security authentication are input into an interface associated with application 202) occurs (602). Once retrieved, an interface (e.g., interface 402 (FIGS. 4A-4H); interface 502 (FIGS. 5A-5D)) is generated using the retrieved files (604). Files may be stored in and retrieved from a repository (e.g., repository 222 (FIG. 2)) and created, authored, scripted, developed, coded, or otherwise developed using any type of computer programming or formatting language, script, protocol, or format. The generated interface is presented, including the personal inventory associated with the account and any items included within the personal inventory (606). Once presented, a determination is made as to whether an input has been received (608). If no input has been received, application 202 continues to wait for an input and presents the interface providing information for a personal inventory (610). The information may be persistently displayed or occasionally refreshed until input (e.g., input entered using an input device (e.g., keyboard, mouse, voice command interpreter, and others)). If an input is detected, then the input is evaluated to determine if action is indicated (612). A further determination is made as to whether an action has been indicated in the input, which may be a request, message, or submission sent by the user with regard to an item in the personal inventory (614). A request, message, or submission may also be associated with other features or functions (e.g., personal inventory management, account/profile information updates or changes, social networking activities (e.g., sending messages to other users, establishing groups, moderating groups, exchanging information, pictures, images, or others), and others) provided by application 202 (FIG. 2) to a user account. If no action is indicated, no action is taken (i.e., waiting for another action). If action is indicated, then the action is validated to ensure the action is permitted based on the user account's permission settings and authorized features (616). For example, if a user account is not authorized for electronic commerce (i.e., no credit, debit, or other financial information is stored and associated with the user account, thus preventing the user account from purchasing items), the process may end. In other examples, if a user account is not authorized, an error message may be presented on the interface (e.g., interface 402 (FIG. 4), interface 502 (FIG. 5)) or in a pop-up window or dialog box that indicates that the user has engaged in unauthorized or non-permitted activity. After validating the action, the action is performed (617). Once performed, results associated with the action are displayed (618).

As an example of the above-described process, a user may log into her account through a website (i.e., interface) published on the Internet. Application 202 (FIG. 2) detects the login and identifies the user account associated with the login information. Once identified, associated files with the user account's profile, personal inventory, and other stored items are retrieved from repository 222 (FIG. 2) and presented in an interface (e.g., interface 402 (FIG. 4), interface 502 (FIG. 5)). Personal inventory management, social networking, and other features are made available to the user after her log in. In some examples, application 202 may be implemented using web services delivery language (WSDL) and be launched within a secure environment across the World Wide Web (“web”) with an endpoint-rendered interface on a desktop PC, notebook/laptop, mobile phone, mobile computing device, or other device configured to present an interface. Selecting an option, a user may perform an action associated with personal inventory management, social networking, e-commerce, or others. Examples of actions may include engaging in a transaction with another user (i.e., sending a request to borrow, trade, exchange, buy, sell, or loan an item), creating or moderating a group, joining a group, contacting another user, or the like. After validation, the action is performed and any resulting changes are incorporated into information presented in an interface. The above-described process and examples may be varied in order, function, design, implementation, and other aspects and are not limited to the examples shown and described.

FIG. 6B illustrates an exemplary sub-process for personal inventory management and item exchange. Here, an example of a process for handling an action is further described. A determination is made as to whether an input to post an item has been received (620). If no input has been received, then the process ends. If an input to post an item has been received, then the input is evaluated to gather information associated with the item (622). Examples of types of information that may be provided with an item listing were described above, but may also be varied and are not limited to those described above. The information associated with the item and its accompanying listing is stored (e.g., in repository 222 (FIG. 2)) (623). A further determination is made as to whether the information also include a link or pointer to an off-site source or location (i.e., another location or destination found on a website other than that instantiated by system 100, application 202, or the techniques described above) (624). If a link or pointer to an off-site source or location is found, then a link or other user-enabled link is implemented (626). If the link or pointer is selected by a user viewing the item listing, it may direct the user's web browser to the off-site source. As an example, images located at the destination indicated by a web browser may be retrieved and stored for use when, for example, generating other images, thumbnails, or the like. In some examples, the link or pointer may be implemented using a link-enabled icon such as those described above. In other examples, another window may open to display an image or other information associated with the link. In still other examples, a pop-up window or dialog box may open with information, images, or pictures of the item found at the off-site link or source. Alternatively, if no link or pointer to an off-site source or location is found or, after an off-site link or pointer is implemented, then the item listing is posted (628). Further, the above-described process and examples may be varied in order, function, design, implementation, and other aspects and are not limited to the examples shown and described.

FIG. 6C illustrates another exemplary sub-process for personal inventory management and item exchange. Here, further detail is provided when determining whether an action is indicated, as shown and described in connection with 614 above. In some examples, an input is evaluated to determine the type of action being indicated (630). A determination is made as to whether the input indicates a request to borrow an item in the user's personal inventory (632). If the input does not indicate a request to borrow an item, then the input is further evaluated to determine whether the requested action indicates a request to trade (634) or buy (636) the item. If the input does not indicate a request to borrow, trade, or buy the item, then another determination is made as to whether the input indicates another type of action (e.g., social networking or group-related actions, as described above) (638). If the input indicates a request to borrow, trade, buy, or another type of action, then a message is sent and the “Request” page of the item owner's account receives the request (640). Further, an alert message (e.g., e-mail, short messaging system (SMS), text message, or the like) may be sent to the owner's indicated e-mail account to notify the owner of a request. In some examples, a user may configure a profile or account (as described above in connection with FIG. 4B) to receive alert messages. Likewise, a profile may be configured not to send alert messages. Another determination is then made as to whether the owner of the item has responded (642). If a response is received, then additional actions (e.g., initiating a transaction between the requesting user and the item owner, adding a user to a group, deleting a user from a group, moderating a group chat, discussion or blog, exchanging contact information, exchanging items, and others) may be taken based on processing the request (644). However, if no input is required, then application 202 waits for a response (646). In other examples, additional factors that may be considered when making the above-described determinations include factors that are individually specified by a user, such as a type of event for which an item is requested (e.g., birthday, wedding, baby shower, retirement, new job, and the like). In other examples, the above-described process and examples may be varied in order, function, design, implementation, and other aspects and are not limited to those shown and described.

FIG. 6D illustrates yet another exemplary sub-process for personal inventory management and item exchange. Here, another process for handling user requests associated with personal inventory management and social networking is described. In some examples, a request is received (650). A received request is evaluated (652). A determination is made as to whether the request is associated with an item (654). If the request is not associated with an item, then a further determination is made as to whether the request is valid (656). In some examples, requests may also be made in connection with services that may be offered over a personal inventory management and item exchange network. Here, if the request is not valid, then application 202 (FIG. 2) waits for another request (658). In some examples, an error message may also be presented, but is not a limiting feature of the above-described process. If the request is valid, then the request is performed and the process ends (660). However, if the request is associated with an item, then a further determination is made as to whether the request may be performed (662). For example, if an item listing indicates that an item is available for either a trade or purchase, then a request to borrow the item would be rejected (i.e., not accepted). If the request cannot be performed, then an error message is presented (664) and application 202 (FIG. 2) waits for the next request (658). Alternatively, if the request can be performed, then an indication is shown on a Request page, such as that described above in connection with FIG. 4H (666). An alert message is sent to the item owner over, for example, e-mail, SMS, text, or other messaging systems (668) and the process proceeds to FIG. 6E. In other examples, the above-described process and examples may be varied in order, function, design, implementation, and other aspects and are not limited to those shown and described.

FIG. 6E illustrates a further exemplary process for personal inventory management and item exchange. Here, as a continuation to the process described above in connection with FIG. 6D, a determination is made as to whether a request is accepted (670). If the request is not accepted, a message indicating the request was not accepted is sent to the offering user, account, or endpoint (672). If a request is accepted, then an indication (e.g., a status indicator, text, or other visual representation) is presented on the Exchange page of the item owner and the requesting accounts (674). The status of the item is changed to indicate a transaction is pending (676). A determination is made as to whether the exchange has been confirmed (678). In some examples, confirmation of an exchange may occur when an item owner or requesting user (i.e., requester) confirms that an item was sold, traded, bought, loaned, borrowed, or donated as indicated by the request. If an exchange has not been confirmed, then application 202 (FIG. 2) waits for confirmation of the exchange (680). Alternatively, if the exchange has been confirmed, then the status of the item in the item listing is changed to indicate that the item is no longer available for further transactions until the new owner changes the availability of the item or the item is returned to the original item owner and made available for future transactions. In other examples, the above-described process and examples may be varied in order, function, design, implementation, and other aspects and are not limited to those shown and described.

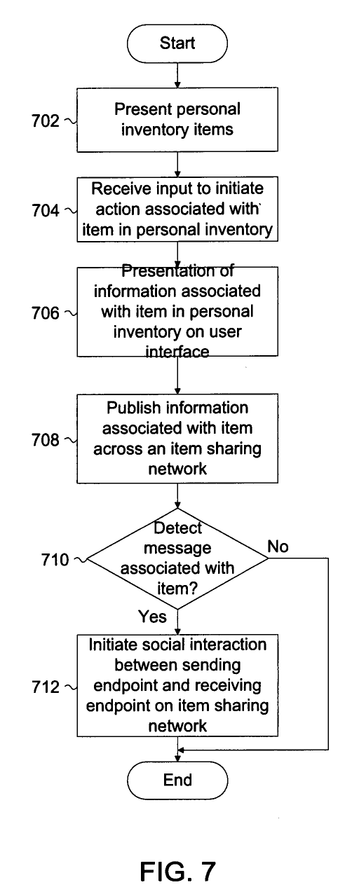

FIG. 7 illustrates an alternative exemplary process for personal inventory management and item exchange. Here, personal inventory items are presented (702). Once presented, input is received to initiate an action associated with one or more items in a personal inventory (704). Based on the results of the action, information associated with the item and the performed action are presented on a user interface (e.g., interface 402 (FIGS. 4A-4H), interface 502 (FIGS. 5A-5D), and others) (706). Information is also published (i.e., sent, uploaded, and otherwise implemented) to other endpoints having interfaces rendered by application 202, which may be implemented using a single or multiple instance in a standalone or distributed architecture (708). A determination is made as to whether a message has been detected associated with an item (710). In other examples, messages may also be sent for other purposes (e.g., to invite another user to engage in social interaction, ask another user or item owner a question, and the like). If a message has been detected, then social network interaction (i.e., social networking activities such as those described above) may be made available between the sending and receiving endpoint (i.e., sending and receiving user accounts and/or the endpoint devices (i.e., any type of computing device) used to send or receive messages associated with personal inventory management or social networking, such as those described above) (712). In some examples, making social network interaction “available” may include monitoring system 100 for requests between user accounts to engage in various transactions. If a message associated with an item is not detected, then the process ends. In other examples, the above-described process and examples may be varied in order, function, design, implementation, and other aspects and are not limited to those shown and described.

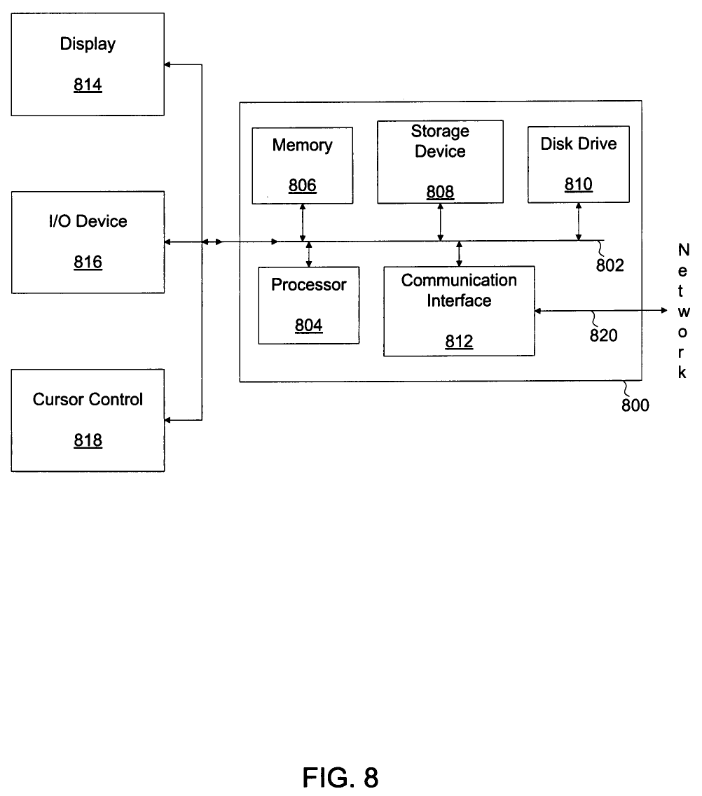

FIG. 8 illustrates an exemplary computer system suitable for personal inventory management and item exchange. In some examples, computer system 800 may be used to implement computer programs, applications, methods, processes, or other software to perform the above-described techniques. Computer system 800 includes a bus 802 or other communication mechanism for communicating information, which interconnects subsystems and devices, such as processor 804, system memory 806 (e.g., RAM), storage device 808 (e.g., ROM), disk drive 810 (e.g., magnetic or optical), communication interface 812 (e.g., modem or Ethernet card), display 814 (e.g., CRT or LCD), input device 816 (e.g., keyboard), and cursor control 818 (e.g., mouse or trackball).

According to some examples, computer system 800 performs specific operations by processor 804 executing one or more sequences of one or more instructions stored in system memory 806. Such instructions may be read into system memory 806 from another computer readable medium, such as static storage device 808 or disk drive 810. In some examples, hard-wired circuitry may be used in place of or in combination with software instructions for implementation.

The term “computer readable medium” refers to any medium that participates in providing instructions to processor 804 for execution. Such a medium may take many forms, including but not limited to, non-volatile media, volatile media, and transmission media. Non-volatile media includes, for example, optical or magnetic disks, such as disk drive 810. Volatile media includes dynamic memory, such as system memory 806. Transmission media includes coaxial cables, copper wire, and fiber optics, including wires that comprise bus 802. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In some examples, execution of the sequences of instructions may be performed by a single computer system 800. According to some examples, two or more computer systems 800 coupled by communication link 820 (e.g., LAN, PSTN, or wireless network) may perform the sequence of instructions in coordination with one another. Computer system 800 may transmit and receive messages, data, and instructions, including program, i.e., application code, through communication link 820 and communication interface 812. Received program code may be executed by processor 804 as it is received, and/or stored in disk drive 810, or other non-volatile storage for later execution.

The foregoing examples have been described in some detail for purposes of clarity of understanding, but are not limited to the details provided. There are many alternative ways and techniques for implementation. The disclosed examples are illustrative and not restrictive.

What is claimed:

1. A method, comprising:
generating an interface using data associated with a personal inventory comprising an item listing, the interface being used to manage the personal inventory, wherein the interface is generated by a system configured to provide one or more options to manage the personal inventory and to prevent access to the personal inventory;
presenting the item listing in the interface, the interface being accessible by one or more endpoints and comprising a marketplace configured to perform an activity associated with the item listing, wherein the data is used to present the item listing on a network, the item listing describing an item; and
receiving an input associated with the item listing, the input indicating initiation of an activity associated with an item described by the item listing.

2. The method of claim 1, further comprising updating the item listing when the input indicating initiation of the activity associated with the item listing indicates modification of the data associated with the item listing.

3. The method of claim 1, further comprising receiving an offer associated with the item listing, the offer being provided over the network from an endpoint not associated with the personal inventory, the endpoint being configured to view data associated with the item listing and not the personal inventory.

4. The method of claim 1, further comprising confirming an exchange of the item, wherein a status associated with the item is updated when the exchange is confirmed.

5. The method of claim 1, further comprising generating a contact list, wherein a contact is added using a script, the script being initiated by selecting one or more elements displayed on the interface.

6. The method of claim 1, wherein the network is configured to enable social interaction between the one or more accounts.

7. The method of claim 1, managing one or more requests associated with the item listing, wherein a plurality of requests are aggregated by the network and presented on the interface.

8. The method of claim 7, wherein the network is coupled to an auction-based marketplace website.

9. The method of claim 7, wherein the network is coupled to a classifieds website.

10. The method of claim 1, wherein access to the personal inventory and the item listing is restricted, the access being restricted by controlling access to the data associated with the personal inventory and the item listing.

11. The method of claim 1, wherein generating the interface is based on one or more settings associated with the item listing, at least one of the one or more settings being associated with availability associated with the item.

12. The method of claim 1, wherein generating the interface further comprises presenting a list configured to display a plurality of item listings.

13. The method of claim 1, wherein the activity comprises trading the item.

14. The method of claim 1, wherein the activity comprises lending the item.

15. The method of claim 1, wherein the activity comprises selling the item.

16. The method of claim 1, wherein the activity comprises requesting the item.

17. The method of claim 1, wherein the activity associated with the item comprises tracking a status of the item.

18. The method of claim 1, wherein the activity comprises donating the item.

19. The method of claim 1, wherein the input indicates a request associated with the item, the request indicating an offer.

20. The method of claim 1, wherein the input indicates confirmation of an exchange associated with the item, the confirmation initiating an update of the personal inventory.

21. The method of claim 1, further comprising presenting a status associated with the item listing.

22. The method of claim 21, wherein the status changes and the personal inventory and the item listing are updated when an action associated with the item is detected.

23. A system, comprising:
a database configured to store data associated with an item in a personal inventory; and
a processor configured to generate an interface using data associated with a personal inventory comprising an item listing, the interface being used to manage the personal inventory, wherein the interface is generated by a system configured to provide one or more options to manage the personal inventory and to prevent access to the personal inventory, to present the item listing in the interface, the interface being accessible by one or more endpoints and comprising a marketplace configured to perform an activity associated with the item listing, wherein the data is used to present the item listing on a network, the item listing describing an item, and to receive an input associated with the item listing, the input indicating initiation of an activity associated with an item described by the item listing.

24. A computer program product embodied in a computer readable medium and comprising computer instructions for:
generating an interface using data associated with a personal inventory comprising an item listing, the interface being used to manage the personal inventory, wherein the interface is generated by a system configured to provide one or more options to manage the personal inventory and to prevent access to the personal inventory;
presenting the item listing in the interface, the interface being accessible by one or more endpoints and comprising a marketplace configured to perform an activity associated with the item listing, wherein the data is used to present the item listing on a network, the item listing describing an item; and
receiving an input associated with the item listing, the input indicating initiation of an activity associated with an item described by the item listing.
